(19) United States
(12) Patent Application Publication
(10) Pub. No.: US 2026/0372116 A1
(43) Pub. Date: Nov. 19, 2026

(54) METHOD OF ROUTING TRACES OF AN INTERCONNECT STRUCTURE

(71) Applicant: Taiwan Semiconductor Manufacturing Company, Ltd., Hsinchu (TW)

(72) Inventors: Hung-Jen HSU, Hsinch (TW); Hsin-Ying LIN, Tainan (TW); Huang-Yu CHEN, Zhudong (TW); Chih-Wei CHANG, Taipei (TW); Yun-Han LEE, Baoshan (TW)

(73) Assignee: Taiwan Semiconductor Manufacturing Company, Ltd., Hsinchu (TW)

(21) Appl. No.: 19/754,652

(22) Filed: Jul. 27, 2026

Related U.S. Application Data
(63) Continuation of application No. 19/056,188, filed on Feb. 18, 2025.
(60) Provisional application No. 63/708,372, filed on Oct. 17, 2024.

(51) Int. Cl. H10W 46/00; H10W 70/63; H10W 70/65; H10W 90/00

(52) U.S. Cl. CPC H10W 46/00; H10W 70/635; H10W 70/65; H10W 90/701; H10W 46/103; H10W 46/403

(57) ABSTRACT

An embodiment method of routing traces of an interconnect structure includes deriving first capacity information of a first plurality of routing nodes in a first area of the interconnect structure and generating a first plurality of predicted traces connecting the first plurality of routing nodes based on the first capacity information. The method of routing traces of the interconnect structure includes deriving second capacity information of a second plurality of routing nodes in a second area of the interconnect structure, and generating a second plurality of predicted traces connecting the second plurality of routing nodes based on the second capacity information. The method of routing traces of the interconnect structure further includes generating a plurality of traces connecting the first plurality of routing nodes and the second plurality of routing nodes based on the first plurality of predicted traces and the second plurality of predicted traces.

### PRIORITY CLAIM AND CROSS-REFERENCE

This patent application is a continuation of U.S. patent application Ser. No. 19/056,188, filed Feb. 18, 2025, which claims the benefit of U.S. Provisional Patent Application No. 63/708,372, filed on Oct. 17, 2024, the entire disclosures of which are hereby incorporated herein by reference.

### BACKGROUND

A semiconductor die is connectable to other devices external to the semiconductor die through various types of interconnect structures, including a redistribution structure attached to the semiconductor die, an interposer, a packaging substrate, a combination thereof, or the like. In some applications, an interconnect structure includes one or more metallization layers, and each metallization layer includes traces connecting the bumps or via structures in one area to the bumps or via structures in another area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1D are cross-sectional views of integrated circuit (IC) device examples based on various packaging technologies, in accordance with some embodiments.

FIG. 2 is a node map of a routing task example, in accordance with some embodiments.

FIG. 3 is a flow chart of a process flow example for routing traces of an interconnect structure, in accordance with some embodiments.

FIG. 4 is a flow chart of a process flow example for generating track mapping graphs with edge attributes, in accordance with some embodiments.

FIG. 5 is a flow chart of a process flow example for deriving track mapping solutions and generating track mapping graphs with edge attributes, in accordance with some embodiments.

FIGS. 6A-6F are diagrams of the routing task example in FIG. 2 at different stages of the flow chart in FIG. 3, in accordance with some embodiments.

FIGS. 7A-7G are diagrams of various types of track mapping solutions, in accordance with some embodiments.

FIGS. 8A-8D are flow charts of different process flow examples for identifying track mapping solutions, in accordance with some embodiments.

FIG. 9A is a flow chart of a process flow example for imposing one or more modifications to ensure presence of at least one feasible track mapping solution, in accordance with some embodiments.

FIGS. 9B-9D are diagrams of node map examples with corresponding track mapping solutions, in accordance with some embodiments.

FIG. 10 is a diagram of a routing example based on a monotonic routing process, in accordance with some embodiments.

FIGS. 11A-11B are diagrams of node map examples with edges, in accordance with some embodiments.

FIG. 12A is a flow chart of a process flow example for setting up routing edges, in accordance with some embodiments.

FIGS. 12B-12E are diagrams of node map examples at different stages of the flow chart in FIG. 12A, in accordance with some embodiments.

FIGS. 13A-13B are diagrams of node map examples for determining an extra edge based on a first capacity-based method, in accordance with some embodiments.

FIGS. 13C-13D are diagrams of node map examples for determining an extra edge based on a second capacity-based method, in accordance with some embodiments.

FIGS. 14A-14C are diagrams of node map examples for determining an extra edge based on a route-based method, in accordance with some embodiments.

FIG. 15 is a flowchart of a method of routing traces of an interconnect structure, in accordance with some embodiments.

FIG. 16 is a block diagram of an electronic design automation (EDA) system in accordance with some embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of.” In this disclosure, the phrase “one of A, B, and C” means “A, B, and/or C” (A, B, C, A and B, A and C, B and C, or A, B and C), and does not mean one element from A, one element from B, and one element from C, unless otherwise described.

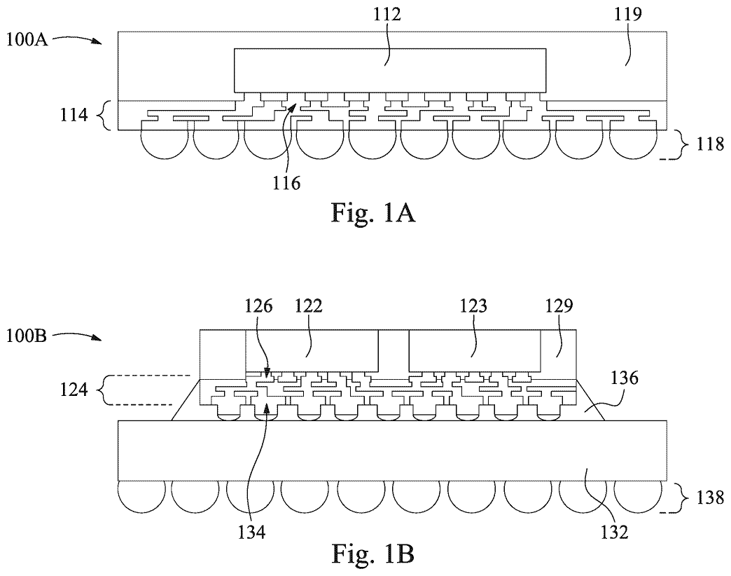

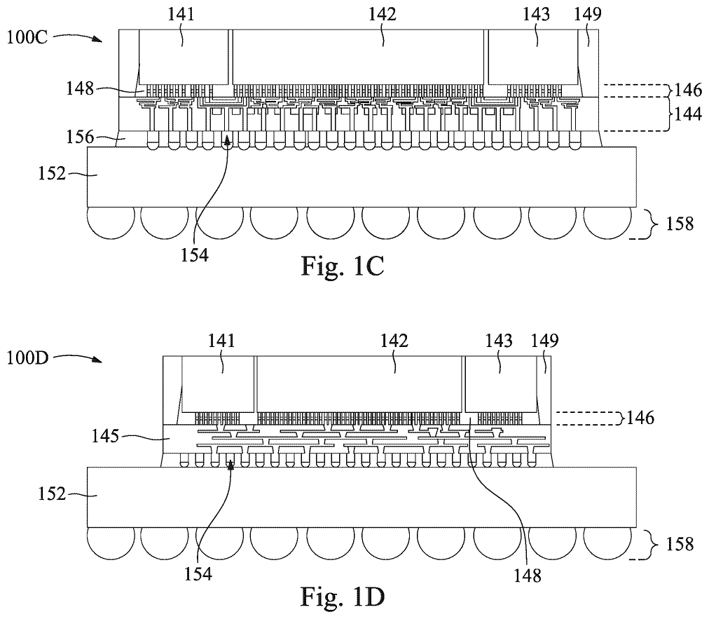

FIGS. 1A-1D are cross-sectional views of integrated circuit (IC) device examples 100A, 100B, 100C, and 100D based on various packaging technologies, in accordance with some embodiments. In some embodiments, each of the (IC) device examples 100A, 100B, 100C, and 100D includes one or more interconnecting structures based on one or more embodiments illustrated in the present disclosure.

In FIG. 1A, IC device example 100A is based on a wafer-level chip scale packing (WLCSP) technology. IC device example 100A includes one or more semiconductor dies, such as a semiconductor die 112, disposed on a redistribution structure 114. In some embodiments, a lower surface of semiconductor die 112 is coupled to an upper surface of redistribution structure 114 through a first set of conductive terminal structures 116 (e.g., conductive structures formed based on conductive pads of semiconductor die 112 and as a portion of redistribution structure 114). In some embodiments, IC device example 100A includes a second set of conductive terminal structures 118 (e.g., copper pillar bumps, solder bumps, or the like) on a lower surface of redistribution structure 114. IC device example 100A further includes an insulation structure 119 encapsulating semiconductor die 112 and covering the upper surface of redistribution structure 114. In some embodiments, insulation structure 119 includes an epoxy polymer material.

In FIG. 1B, IC device example 100B is based on an integrated fan-out on-substrate (InFo_oS) packaging technology. IC device example 100B includes one or more semiconductor dies, such as semiconductor dies 122 and 123, disposed on a redistribution structure 124. In some embodiments, the lower surfaces of semiconductor dies 122 and 123 are coupled to an upper surface of redistribution structure 124 through a first set of conductive terminal structures 126 (e.g., conductive structures formed based on conductive pads of semiconductor dies 122 and 123 and as a portion of redistribution structure 124). IC device example 100B further includes an insulation structure 129 encapsulating semiconductor dies 122 and 123 and covering the upper surface of redistribution structure 124.

Moreover, IC device example 100B includes a substrate 132, where a lower surface of redistribution structure 124 is coupled to an upper surface of substrate 132 through a second set of conductive terminal structures 134 (e.g., a ball grid array, micro bumps, copper pillar bumps, solder bumps, controlled-collapse chip connection (C4) bumps, or the like). In some embodiments, IC device example 100B includes an underfill structure 136 filling the gap between the lower surface of redistribution structure 124 and the upper surface of substrate 132 and surrounding the conductive terminal structures 134. IC device example 100B includes a third set of conductive terminal structures 138 (e.g., copper pillar bumps, solder bumps, or the like) on a lower surface of substrate 132.

In FIG. 1C, IC device example 100C is based on a chip on wafer on substrate with silicon interposer (CoWoS-S) packaging technology. IC device example 100C includes one or more semiconductor dies, such as semiconductor dies 141, 142, and 143, on a silicon interposer 144. In some embodiments, the lower surfaces of semiconductor dies 141, 142, and 143 are coupled to an upper surface of silicon interposer 144 through a first set of conductive terminal structures 146 (e.g., a ball grid array, micro bumps, copper pillar bumps, solder bumps, controlled-collapse chip connection (C4) bumps, or the like). In some embodiments, IC device example 100C includes a first underfill structure 148 filling the gap between the lower surfaces of semiconductor dies 141, 142, and 143 and the upper surface of silicon interposer 144 and surrounding the conductive terminal structures 146. IC device example 100C further includes an insulation structure 149 encapsulating semiconductor dies 141, 142, and 143 and covering the upper surface of silicon interposer 144.

Moreover, IC device example 100C includes a substrate 152, where a lower surface of silicon interposer 144 is coupled to an upper surface of substrate 152 through a second set of conductive terminal structures 154 (e.g., a ball grid array, micro bumps, copper pillar bumps, solder bumps, controlled-collapse chip connection (C4) bumps, or the like). In some embodiments, IC device example 100C includes an underfill structure 156 filling the gap between the lower surface of silicon interposer 144 and the upper surface of substrate 152 and surrounding the conductive terminal structures 154. IC device example 100C includes a third set of conductive terminal structures 158 (e.g., copper pillar bumps, solder bumps, or the like) on a lower surface of substrate 132.

In FIG. 1D, IC device example 100D is based on a chip on wafer on substrate with redistribution interposer (CoWoS-R) packaging technology. In some embodiments, compared to IC device example 100C, IC device example 100D includes a redistribution interposer 145 in place of silicon interposer 144. Other components in FIG. 1D that are the same or similar to those in FIG. 1C are given the same reference numbers, and detailed description thereof is omitted.

In some embodiments, each one of redistribution structure 114 in FIG. 1A, redistribution structure 124 in FIG. 1B, substrate 132 in FIG. 1B, silicon interposer 144 in FIG. 1C, redistribution interposer 145 in FIG. 1D, and/or substrate 152 in FIG. 1C or FIG. 1D includes one or more layers of interconnect structures (e.g., metallization layer or trace layers). In some embodiments, each layer of interconnect structure of redistribution structure 114 in FIG. 1A, redistribution structure 124 in FIG. 1B, substrate 132 in FIG. 1B, silicon interposer 144 in FIG. 1C, redistribution interposer 145 in FIG. 1D, and/or substrate 152 in FIG. 1C or FIG. 1D includes traces connecting the bumps or via structures in one area to the bumps or via structures in another area.

In some examples, a routing task for routing traces of an interconnect structure is performed based on (i) obtaining a global routing evaluation to find a possibly feasible floorplan, and (ii) executing a detailed routing procedure. In some examples, in response to the result of the detailed routing procedure indicating that the floorplan based on the global routing evaluation is not routable or needs further adjustment, the process returns to updating the global routing evaluation and then executing the detailed routing procedure based on the updated global routing evaluation. In some examples, issues justifying adjustment include one or more of routing congestion (e.g., too many traces passing through a space between two adjacent nodes), open or short routing (e.g., no non-crossing path for trace), and/or non-monotonic routing (e.g., a trace crossing an orthogonal cross-section along a propagating direction more than once). As such, multiple trial-and-error iterations may be needed in order to obtain an acceptable solution to the routing task.

In some examples, the routing task performed based on multiple trial-and-error iterations could be time-consuming. As the size of packages increases, the size and complexity of the corresponding routing task increases, and the number of iterations (together with computation complexity and processing time) for reaching acceptable solutions increases as well.

Based on one or more embodiments of the present disclosure, a routing task is performed using the track sequence information of routing nodes (e.g., corresponding to bumps or via structures) and associated edge attributes (e.g., indicating one or more passing track sequence indexes of an edge and/or a number of traces accommodable by the edge). Based on one or more embodiments of the present disclosure, the traces of the routing task are determined efficiently and precisely without engaging in trial-and-error iterations. In some embodiments, several benefits based on one or more embodiments of the present disclosure include accurate congestion prediction, fast trace prediction, easy capacity optimization by prediction, and/or efficient physical monotonic any-angle routing by prediction.

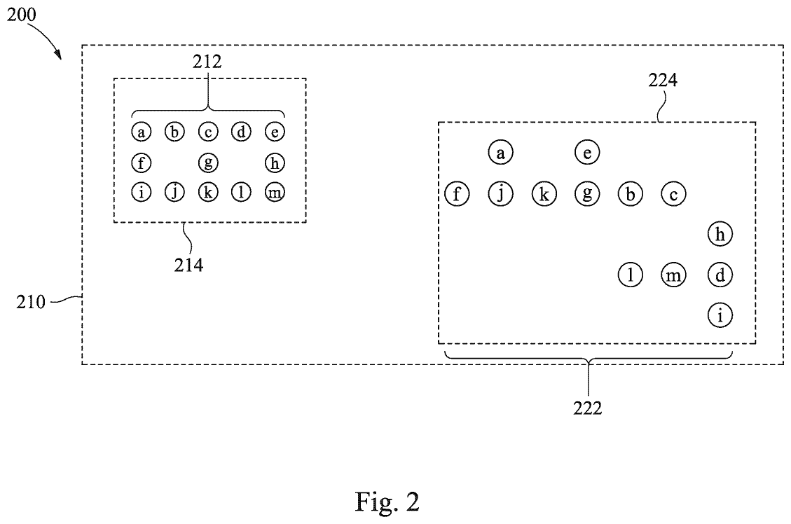

FIG. 2 is a node map 200 of a routing task example for routing traces of an interconnect structure 210, in accordance with some embodiments. In some embodiments, the routing task example based on node map 200 is used as a non-limiting example on which various routing operations illustrated in this disclosure are based. In this non-limiting example, the routing task corresponds to routing traces to connect a first plurality of routing nodes (e.g., represented by 13 circles and collectively identifiable by reference number “212”) in a first area 214 of interconnect structure 210 and a second plurality of routing nodes (e.g., represented by 13 circles and collectively identifiable by reference number “222”) in a second area 224 of interconnect structure 210. In this example, each node of the first plurality of routing nodes 212 is labeled by a corresponding alphabet letter {a, b, . . . , m}, and each node of the second plurality of routing nodes 222 is also labeled by a corresponding alphabet letter {a, b, . . . , m}. In node map 200, two nodes that are to be electrically coupled by a trace determined based on performing the routing task example are indicated using the same alphabet letter.

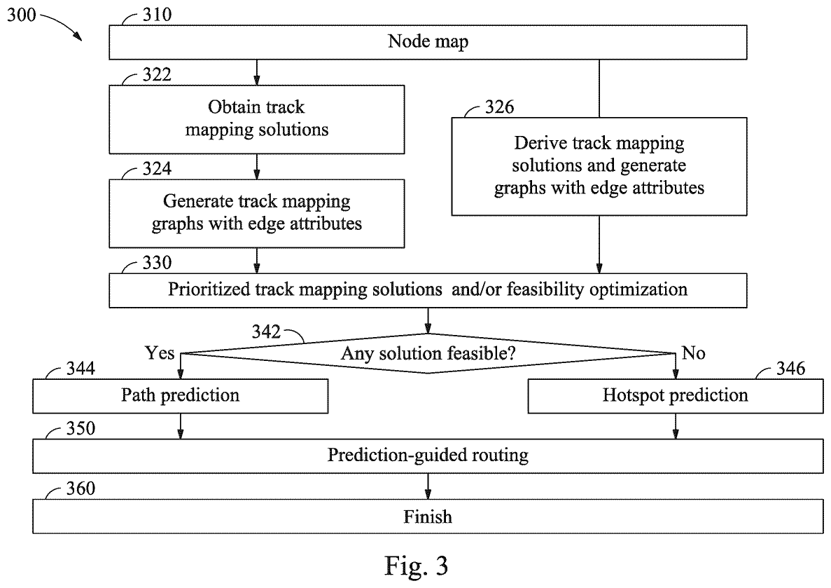

FIG. 3 is a flow chart of a process flow example 300 for routing traces of an interconnect structure, in accordance with some embodiments. The flow chart in FIG. 3 includes stages 310-360 of process flow 300. In some embodiments, process flow 300 includes additional stages not included in FIG. 3. In some implementations, one or more stages in FIG. 3 are simplified, modified, or omitted. In some embodiments, the stages in FIG. 3 are performed by one or more processing devices operated by one entity (e.g., one or more designers of one company) or multiple processing devices operated by one or more entities (e.g., one designer operating different electronic design automation (EDA) systems, multiple designers of one company operating different EDA systems, multiple designers of different companies operating different EDA systems, or the like).

In FIG. 3, process flow 300 begins at stage 310, where a node map (e.g., the node map 200 in FIG. 2) of a routing task is prepared or obtained. In some embodiments, each node in the node map corresponds to a via structure or a bump to be connected by a trace in a particular layer of an interconnect structure. In some embodiments, a node map includes a first plurality of routing nodes in a first area (e.g., first area 214 in FIG. 2) of the interconnect structure and a second plurality of routing nodes in a second area (e.g., second area 224 in FIG. 2) of the interconnect structure.

At stages 322, 324, and 326, one or more track mapping graphs with edge attributes for the routing nodes in the node map are generated. In some embodiments, the edge attributes correspond to first capacity information of the first plurality of routing nodes and second capacity information of the second plurality of routing nodes. In some embodiments, the first plurality of routing nodes and two virtual routing boundaries define a first plurality of routing edges, and the first capacity information indicates one or more passing track sequence indexes for, and/or a number of traces accommodable by, each routing edge of a subset of the first plurality of routing edges. In some embodiments, the second plurality of routing nodes and the two virtual routing boundaries define a second plurality of routing edges, and the second capacity information indicates one or more passing track sequence indexes for, and/or a number of traces accommodable by, each routing edge of a subset of the second plurality of routing edges.

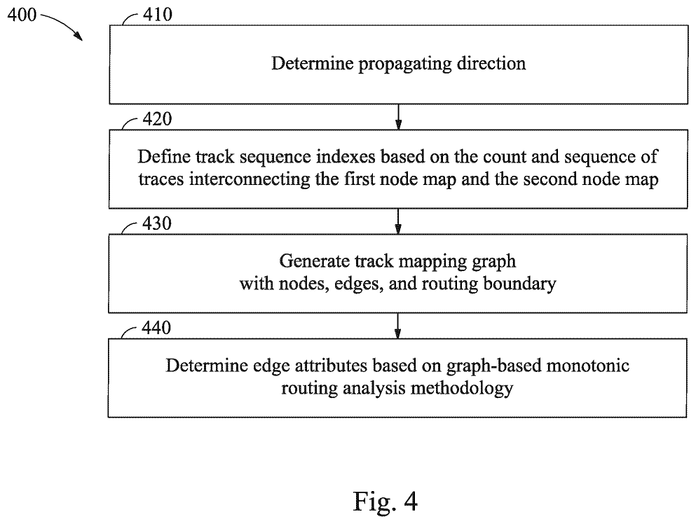

In some embodiments, at stage 322, one or more track mapping solutions corresponding to the node map are obtained from a designer or another processing device. In some embodiments, at stage 324, one or more track mapping graphs are generated based on the one or more track mapping solutions and the node map with inclusion of the edge attributes. In some embodiments, efficacy and efficiency of optimizing capacity and realizing practical routing for a routing task is improved based on the generated one or more track mapping graphs with the edge attributes. In some embodiments, at stage 326, one or more track mapping solutions are derived based on the node map, and one or more track mapping graphs are generated based on the one or more track mapping solutions and the node map with inclusion of the edge attributes. Additional details regarding stages 324 and 326 are illustrated in view of at least FIGS. 4, 5, and 8A-8D.

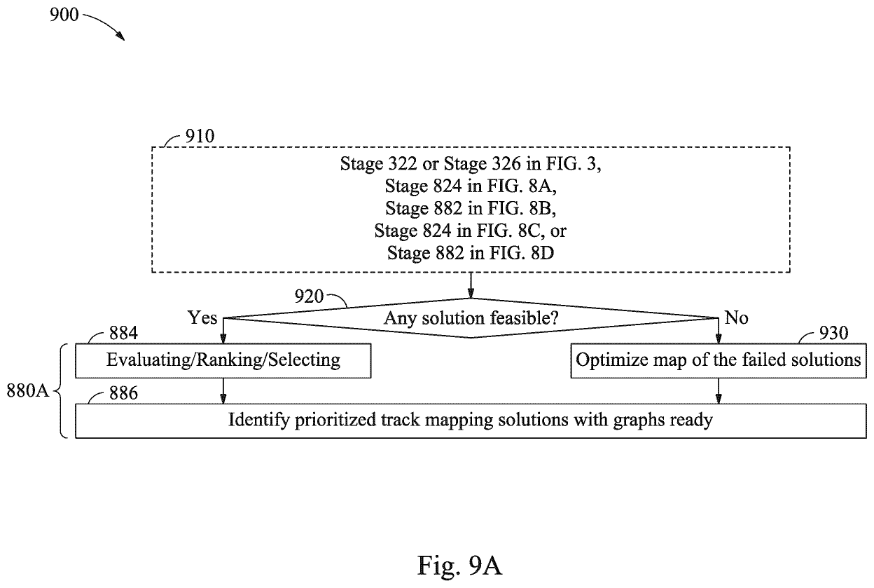

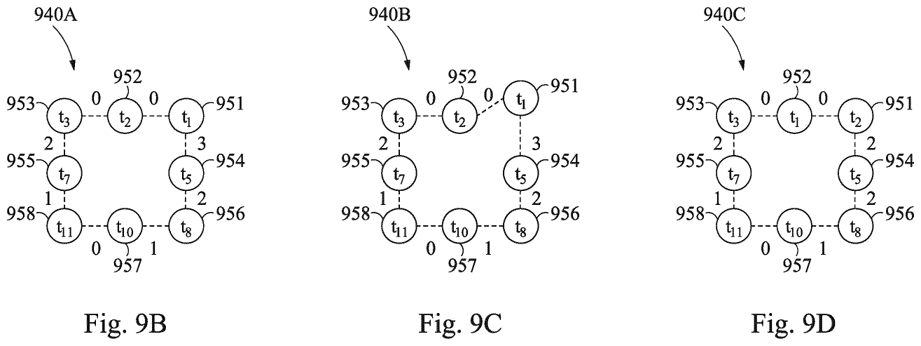

In some embodiments, at stage 330, the one or more track mapping solutions are further prioritized based on one or more requests or criteria imposed by a designer. In some embodiments, the one or more requests or criteria correspond to precise length matching, lower electrical interference, or the like. In some embodiments, at stage 330, in response to a decision that there is no feasible track mapping solution from stage 324 or stage 326, the edge attributes may not be suitable for routing or even derivable. In such scenario, at stage 330, one or more modifications to the track sequence information, the node map, or both, are imposed to increase the chance of the identifying or obtaining at least one feasible track mapping solution, and the corresponding track mapping graph and the associated edge attributes are updated accordingly. Additional details regarding stage 330 are illustrated in view of at least FIGS. 9A-9D.

As discussed above, the track mapping graph and the associated edge attributes from stage 330 indicate the first capacity information of the first plurality of routing nodes and the second capacity information of the second plurality of routing nodes. At stage 342, a track mapping graph is checked for correspondence with a feasible solution. If the track mapping graph corresponds to at least one solution that is feasible, the process proceeds to stage 344. If the track mapping graph corresponds to no feasible solution, the process proceeds to stage 346.

According to stage 344, a portion or all of the predicted traces are generated based on a path prediction method, which corresponds to an identity-based prediction method based on identities of passing track sequence indexes in association with corresponding ones of the first plurality of routing edges included in the first capacity information and/or identities of passing track sequence indexes in association with corresponding ones of the second plurality of routing edges included in the second capacity information. At stage 346, a portion or all of the predicted traces are generated based on a hotspot prediction method, which corresponds to a resource analysis-based prediction method based on the number of traces accommodable by the corresponding ones of the first plurality of routing edges included in the first capacity information and/or the number of traces accommodable by the corresponding ones of the second plurality of routing edges included in the second capacity information.

At stage 350, a plurality of traces connecting the first plurality of routing nodes and the second plurality of routing nodes are generated based on the first plurality of predicted traces and the second plurality of predicted traces. In some embodiments, the plurality of traces generated according to process flow 300 corresponds to a prediction-guided practical routing generated in a single shot (e.g., no need for trial-and-error iterations). In some embodiments, the plurality of traces generated according to process flow 300 is monotonic-guaranteed provided that the monotonic considerations have been adopted within various stages of process flow 300. After stage 350, the process finishes at stage 360.

FIG. 4 is a flow chart of a process flow example 400 for generating track mapping graphs with edge attributes, in accordance with some embodiments. In some embodiments, process flow example 400 corresponds to one or more operations at stage 326 in FIG. 3. The flow chart in FIG. 4 includes stages 410-440 of process flow 400.

In FIG. 4, process flow 400 begins at stage 410, where a propagating direction of the plurality of traces connecting the first plurality of routing nodes and the second plurality of routing nodes is determined. In some embodiments, the propagating direction is derivable based on positions of the first plurality of routing nodes and the second plurality of routing nodes indicated by the node map from stage 310. At stage 420, the association information regarding the track sequence indexes and the resulting traces is defined based on the count and sequence of traces interconnecting the first plurality of routing nodes and the second plurality of routing nodes.

In some embodiments, in response to the track sequence information obtained from a designer or another processing device, stages 410 and 420 are omitted.

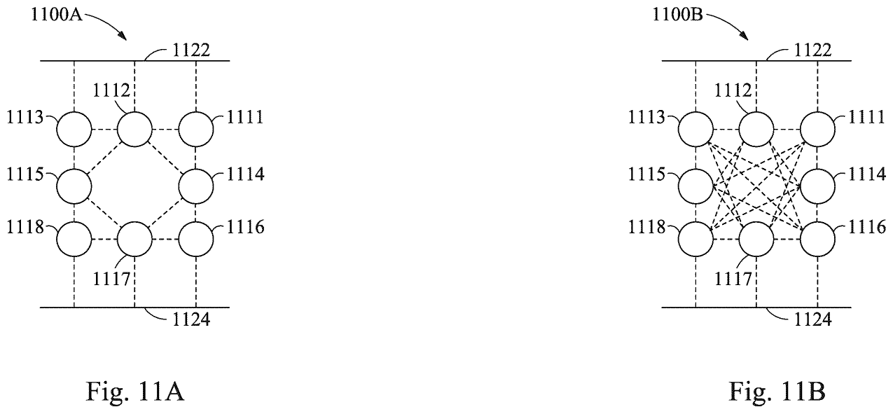

At stage 430, the track mapping graph (with nodes, edges, and routing boundaries, and without the edge attributes) is generated based on the track sequence information and the node map. At stage 440, the edge attributes of various edges in the track mapping graph are determined based on a graph-based monotonic routing analysis methodology. Additional details regarding stage 430 and 440 are illustrated in view of at least FIGS. 11A-14C.

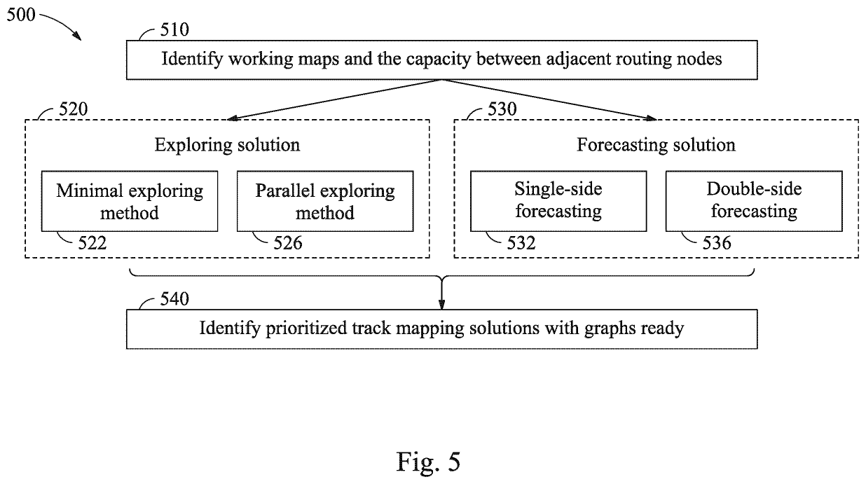

FIG. 5 is a flow chart of a process flow example 500 for deriving track mapping solutions and generating track mapping graphs with edge attributes, in accordance with some embodiments. In some embodiments, the flow chart in FIG. 5 corresponds to operations of stage 326 in FIG. 3. The flow chart in FIG. 5 includes stages 510-540 of process flow 500. In some embodiments, process flow 500 includes additional stages not included in FIG. 5. In some implementations, one or more stages in FIG. 5 are simplified, modified, or omitted.

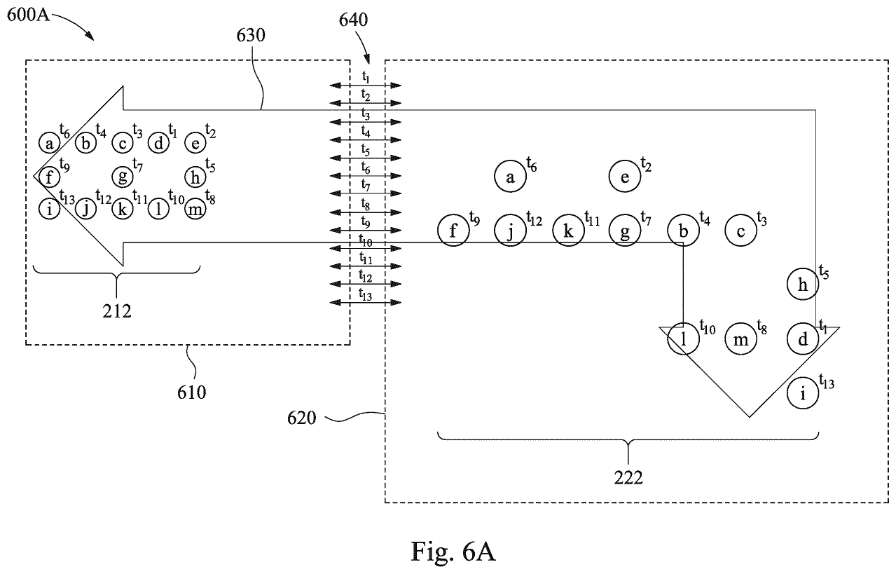

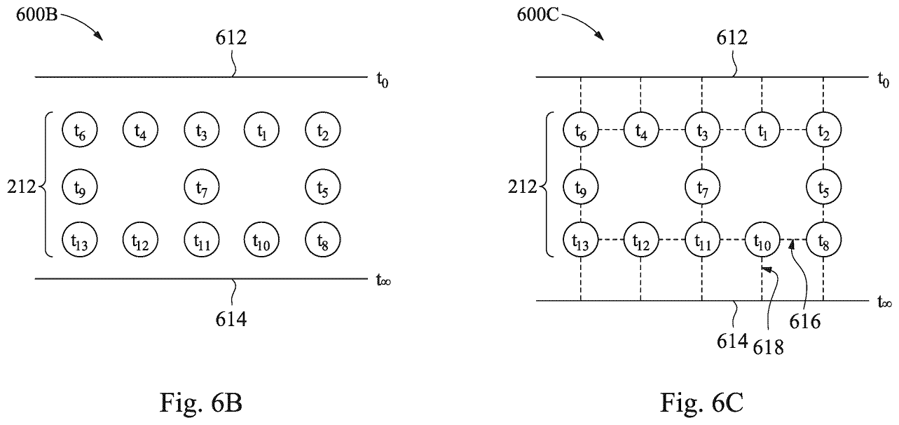

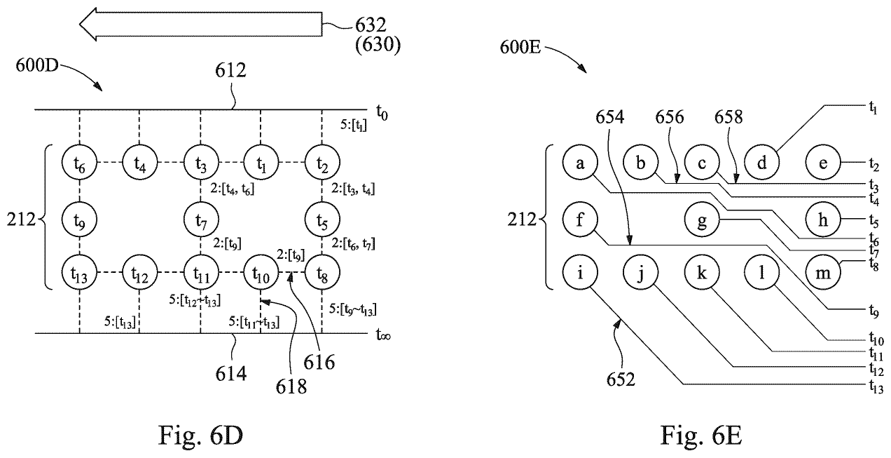

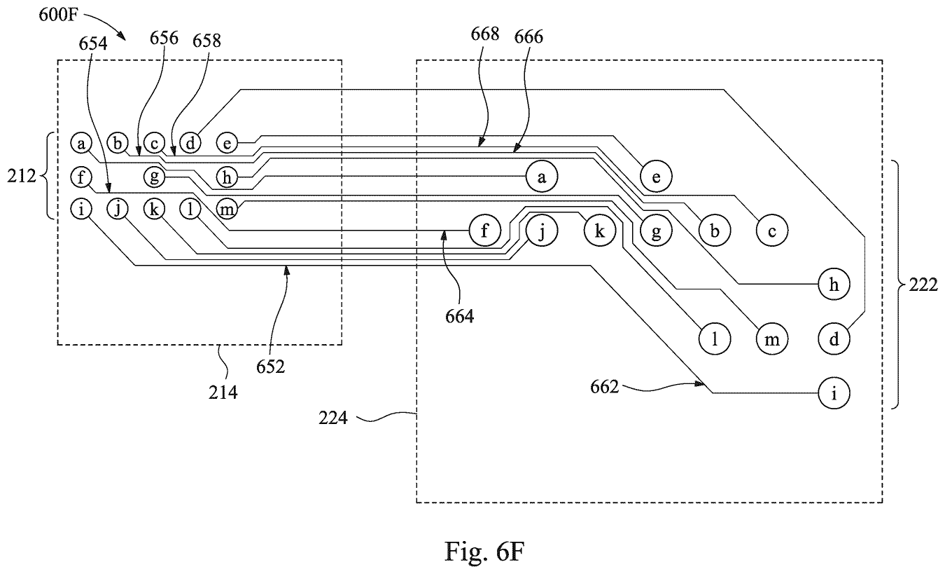

In FIG. 5, process flow 500 begins at stage 510, where two working maps (e.g., working maps 610 and 620 in FIG. 6A) are identified based on the node map (e.g., the node map 200 in FIG. 2). In some embodiments, each one of the resulting traces connects one routing node in a first working map (e.g., corresponding to first working map 610 in FIG. 6A) and another routing node in a second working map (e.g., corresponding to second working map 620 in FIG. 6A). In some embodiments, the working maps are categorized based on the capacity for accommodating traces between two adjacent routing nodes. For example, the first plurality of routing nodes included in a first working map corresponding to first area 214 in FIG. 2 is arranged based on a first pitch and a first capacity of two (2) traces between two adjacent routing nodes. Also, the second plurality of routing nodes included in a second working map corresponding to second area 224 in FIG. 2 are arranged based on a second pitch and a second capacity of seven (7) traces between two adjacent routing nodes. As such, in this non-limiting example and based on various design constraints (e.g., routing nodes corresponding to via structures or different types of bumps and pitches), the first working map has a lesser capacity between adjacent routing nodes, and the second working map has a relatively greater capacity between adjacent routing nodes.

After stage 510, process flow 500 proceeds to stage 520, stage 530, or both, to determine possible track mapping solutions on which the predicted traces are based. At stage 520, possible track mapping solutions are determined based on one or more exploring methods, including a minimal exploring method corresponding to stage 522 and a parallel exploring method corresponding to stage 526. At stage 530, possible track mapping solutions are determined based on one or more forecasting methods, including a single-side forecasting method corresponding to stage 532 and a double-side forecasting method corresponding to stage 536. At stage 540, after stage 520 and/or stage 530, one or more track mapping solutions are identified and prioritized based on the explored solutions from stage 520 and/or the forecasted solutions from stage 530. At stage 540, the track mapping graph and the corresponding edge attributes are determined and ready based on the identified and prioritized track mapping solutions.

FIGS. 6A-6F are diagrams of processing the routing task example in FIG. 2 at different stages of the flow charts in FIG. 3, in accordance with some embodiments. In some embodiments, components in FIGS. 6A-6F that are the same or similar to those in FIG. 2 are given the same reference numbers of reference labels, and description thereof is simplified or omitted.

FIG. 6A is a diagram 600A corresponding to a snapshot of the routing task example at stage 324 or stage 326 in FIG. 3 as a non-limiting example. Diagram 600A includes a first working map 610 corresponding to first area 214 in FIG. 2 and a second working map 620 corresponding to second area 224 in FIG. 2. Diagram 600A includes the first plurality of routing nodes 212 within first working map 610 and the second plurality of routing nodes 222 within second working map 620. Diagram 600A includes a two-way arrow 630 indicating the propagating direction of the to-be-generated traces. Diagram 600A also includes a plurality of arrows 640 representing the track sequence indexes {t1, t2, . . . , t13}. In some embodiments, each one of the track sequence indexes corresponds to a trace to be generated to connect one routing node in first working map 610 and one routing node in second working map 620.

FIG. 6B is a diagram 600B corresponding to a snapshot of a portion of the routing task example (e.g., corresponding to first working map 610) at stage 420 in FIG. 4 as a non-limiting example. Diagram 600B includes the first plurality of routing nodes 212 that are labeled based on the associated track sequence indexes in FIG. 6A. Diagram 600B includes two virtual routing boundaries 612 and 614. In some embodiments, a beginning track sequence index (t0) corresponding to an ordinal position before the plurality of track sequence indexes is assigned to virtual routing boundary 612; and an ending track sequence index (too) corresponding to an ordinal position after the plurality of track sequence indexes is assigned to virtual routing boundary 614.

FIG. 6C is a diagram 600C corresponding to a snapshot of a portion of the routing task example (e.g., corresponding to first working map 610) at stage 430 in FIG. 4 as a non-limiting example. Compared to diagram 600B, diagram 600C further includes routing edges (depicted as broken lines) defined based on the routing nodes 212 and two virtual routing boundaries 612 and 614. For example, a routing edge 616 is defined as connecting routing node ‘l’ (associated with track sequence index t10) and routing node ‘m’ (associated with track sequence index t8). Also, a routing edge 618 is defined as connecting routing node ‘l’ (associated with track sequence index t10) and virtual routing boundary 614 (associated with the ending track sequence index too).

FIG. 6D is a diagram 600D corresponding to a snapshot of a portion of the track mapping graph with the edge attributes at stage 440 in FIG. 4 as a non-limiting example. Diagram 600D includes an arrow 632 (which is a portion of arrow 630) indicating the propagating direction with respect to routing nodes 212. Compared to diagram 600C, diagram 600D further includes the edge attributes for a subset of the routing edges. For example, routing edge 616 is associated with an edge attribute “2: [19]” indicating that a trace associated with the track sequence index “t9” passes routing edge 616, and routing edge 616 has the capacity to accommodate two (2) track sequence indexes. Also, routing edge 618 is associated with an edge attribute “5: [t11~t13]” indicating that traces associated with the track sequence indexes “t11,” “t12,” and ‘t13” pass routing edge 618, and routing edge 618 has the capacity to accommodate five (5) track sequence indexes.

FIG. 6E is a diagram 600E corresponding to a snapshot of a portion of the node map, with predicted traces connecting routing nodes 212 at stage 330 in FIG. 3 as a non-limiting example. In diagram 600E, 13 predicted traces associated with track sequence indexes {t1, t2, . . . , t13} are determined based on the track mapping graph with the edge attributes as illustrated by diagram 600D. For example, predicted traces 652, 654, 656, and 658 are connected to routing nodes labeled as ‘i,’ ‘f,’ ‘b,’ and ‘c’ and are associated with track sequence indexes “t13,” t9,” “t4,” and “t3,” respectively.

FIG. 6F is a diagram 600F corresponding to a snapshot of the node map with determined traces connecting routing nodes 212 and routing nodes 222 at stage 350 in FIG. 3 as a non-limiting example. In diagram 600F, predicted traces connecting to routing nodes 222 (e.g., predicted traces 662, 664, 666, and 668) are determined in a manner similar to the determination of predicted traces 652, 654, 656, and 658. At stage 350, the final traces connecting routing nodes 212 and routing nodes 222 are determined based on the predicted traces and the associated track sequence indexes.

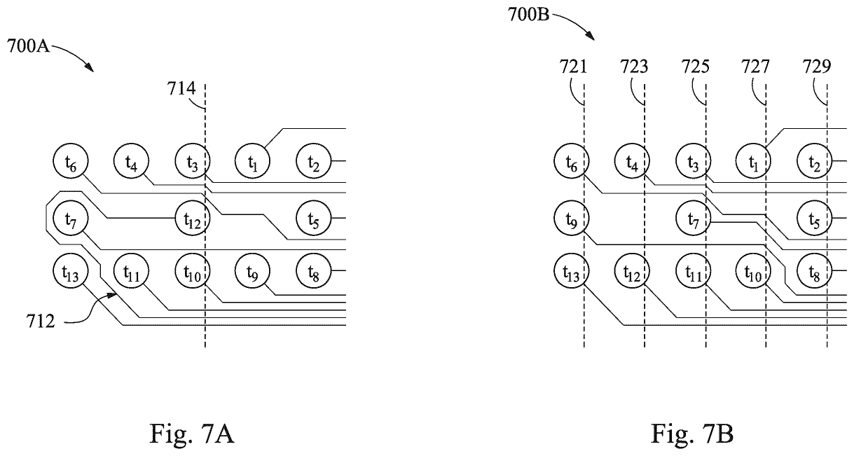

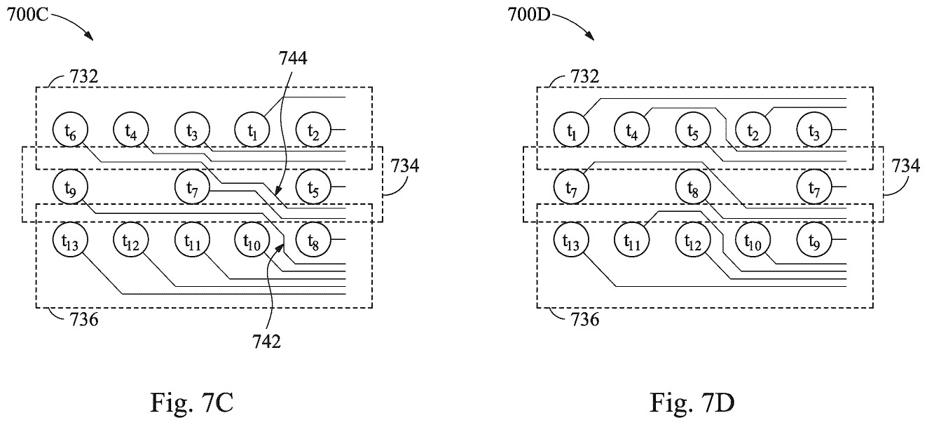

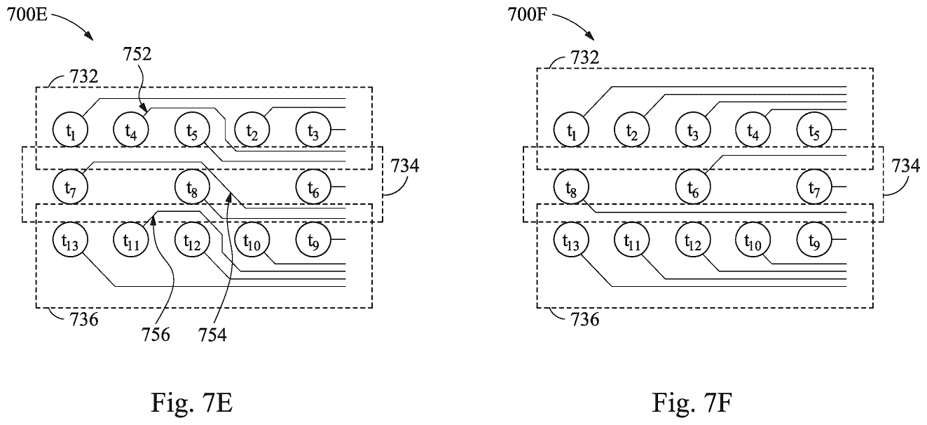

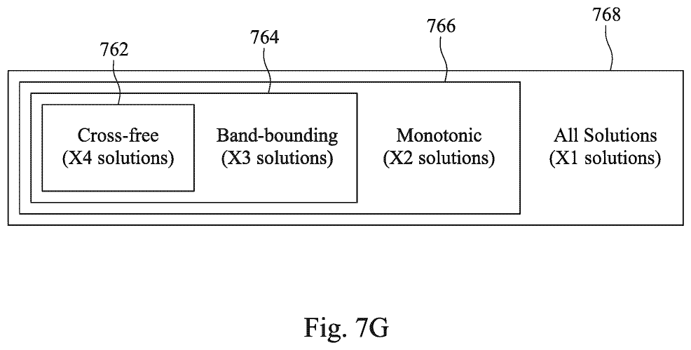

FIGS. 7A-7G are diagrams of various types of track mapping solutions, in accordance with some embodiments. In some embodiments, stage 520 and stage 530 in FIG. 5, and/or stage 326 at FIG. 3 correspond to an algorithm configured to find a particular one of the types of track mapping solutions in FIG. 7G.

FIG. 7A is a diagram of a first track mapping solution example 700A that includes a plurality of routing nodes (depicted as circles) associated with corresponding track sequence indexes (based on labels t1~t13). In FIG. 7A, all features associated with the track sequence index “t12” (including a trace 712 connected to the routing node associated with the track sequence index “t12”) passes a virtual cross-section 714 orthogonal to a propagating direction more than once. Accordingly, first track mapping solution example 700A or the like is referred to as a non-monotonic solution. Also, the track sequence indexes along the virtual cross-section 714 are not assigned in a descending or ascending order.

FIG. 7B is a diagram of a second track mapping solution example 700B that includes a plurality of routing nodes (depicted as circles) associated with corresponding track sequence indexes (based on labels t1~t13). Compared to FIG. 7A, the features in FIG. 7B associated with any track sequence index only pass any given virtual cross-sections 721, 723, 725, 727, and 729 at most once. Accordingly, second track mapping solution example 700B or the like is referred to as a monotonic solution. Also, the track sequence indexes along any of the virtual cross-sections 721, 723, 725, 727, and 729 are assigned in a descending or ascending order (also referred to as having a unified direction of track sequence). In some embodiments, compared to a non-monotonic solution counterpart, a monotonic solution with the unified direction of track sequence consumes less routing resources.

FIG. 7C is a diagram of a third track mapping solution example 700C that includes a plurality of routing nodes (depicted as circles) associated with corresponding track sequence indexes (based on labels t1~t13). FIG. 7C also includes three routing bands 732, 734, and 736. In some embodiments, each one of routing bands 732, 734, and 736 includes only one row of routing nodes. Third track mapping solution example 700C includes a trace 742 that is in both routing band 734 and routing band 736, and a trace 744 that is in both routing band 732 and routing band 734. As such, third track mapping solution example 700C or the like is referred to as a cross-band solution.

FIG. 7D is a diagram of a fourth track mapping solution example 700D that includes a plurality of routing nodes (depicted as circles) associated with corresponding track sequence indexes (based on labels t1~t13). Compared to FIG. 7C, the features in FIG. 7D associated with any track sequence index remain in one of routing bands 732, 734, and 736. Accordingly, fourth track mapping solution example 700D or the like is referred to as a band-bounding solution. In some embodiments, compared to a cross-band solution counterpart, a band-bounding solution also reduces the chance of routing trace turning.

FIG. 7E is a diagram of a fifth track mapping solution example 700E that includes a plurality of routing nodes (depicted as circles) associated with corresponding track sequence indexes (based on labels t1~t13). FIG. 7E also includes three routing bands 732, 734, and 736 as illustrated in FIG. 7C. While all traces of fifth track mapping solution remain in the corresponding routing bands 732, 734, and 736, some traces (e.g., traces 752, 754, and 756) cross the row of routing nodes within the corresponding routing bands 732, 734, and 736. As such, fifth track mapping solution example 700E or the like is referred to as a non-cross-free solution.

FIG. 7F is a diagram of a sixth track mapping solution example 700F that includes a plurality of routing nodes (depicted as circles) associated with corresponding track sequence indexes (based on labels t1~t13). Compared to FIG. 7E, all traces in FIG. 7F do not cross the row of routing nodes within the corresponding routing bands 732, 734, and 736. Accordingly, sixth track mapping solution example 700F or the like is referred to as a cross-free solution. In some embodiments, a cross-free solution is obtainable based on a V-sequence method for each band. In some embodiments, the V-sequence method corresponds to assigning track sequence indexes based on the net sequence (e.g., the corresponding track sequence index) of an (i+1)-th routing node next to an i-th routing node being either the maximum net sequence of 1st~i-th routing nodes plus one (+1) or the minimum net sequence of 1st~i-th routing nodes minus one (−1). In some embodiments, compared to a non-cross-free solution counterpart, a cross-free solution further reduces the resource consumption between nodes.

FIG. 7G is a diagram of the relation among four different types of track mapping solutions, in accordance with some embodiments. In some embodiments, for a particular working map and the routing nodes included therein, cross-free solutions 762 is a subset of band-bounding solutions 764, which is a subset of monotonic solutions 766, which is a subset of all solutions 768.

For example, based on the examples in FIGS. 7A-7F, all solutions 768 based on an exhaustive algorithm include 13!≅6.2×10⁹ solutions; monotonic solutions 766 based on monotonic track assignment include

$${C}_{3}^{13} \times {C}_{2}^{10} \times {C}_{3}^{8} \times {C}_{2}^{5} \times {C}_{3}^{3} ≅ 7.2 \times {10}^{6}$$

solutions; band-bounding solutions 764 based on track grouping by band include 5!×3!×5!≅8.4×10⁴ solutions; and monotonic solutions 762 based on V-sequence method include

$$( {C}_{0}^{4} + {C}_{1}^{4} + {C}_{2}^{4} + {C}_{3}^{4} + {C}_{4}^{4} ) \times ( {C}_{0}^{2} + {C}_{1}^{2} + {C}_{2}^{2} ) \times ( {C}_{0}^{4} + {C}_{1}^{4} + {C}_{2}^{4} + {C}_{3}^{4} + {C}_{4}^{4} ) = 1024$$

solutions.

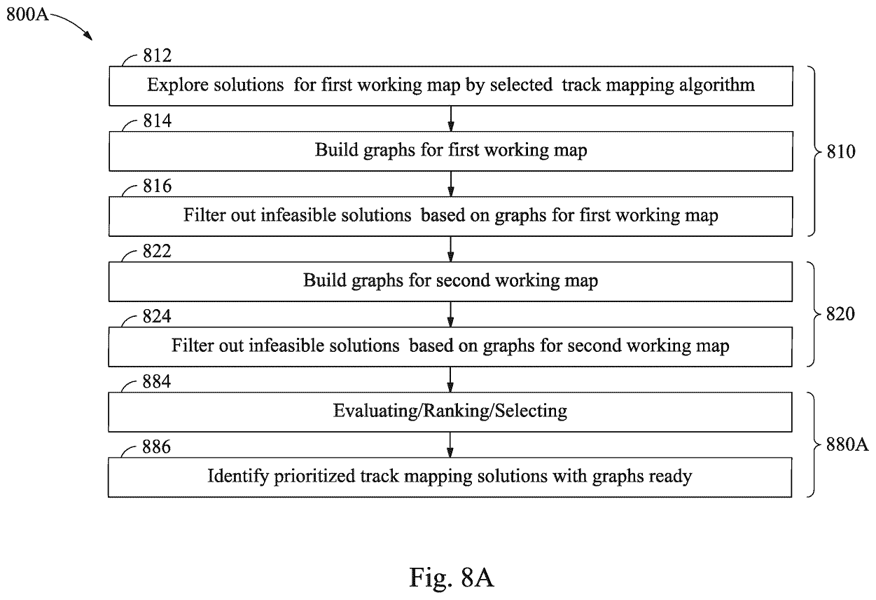

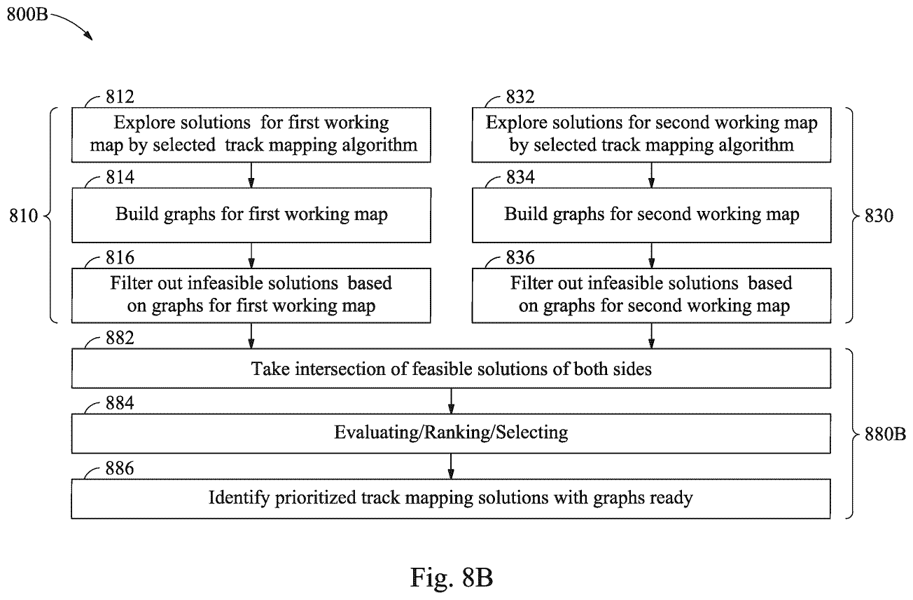

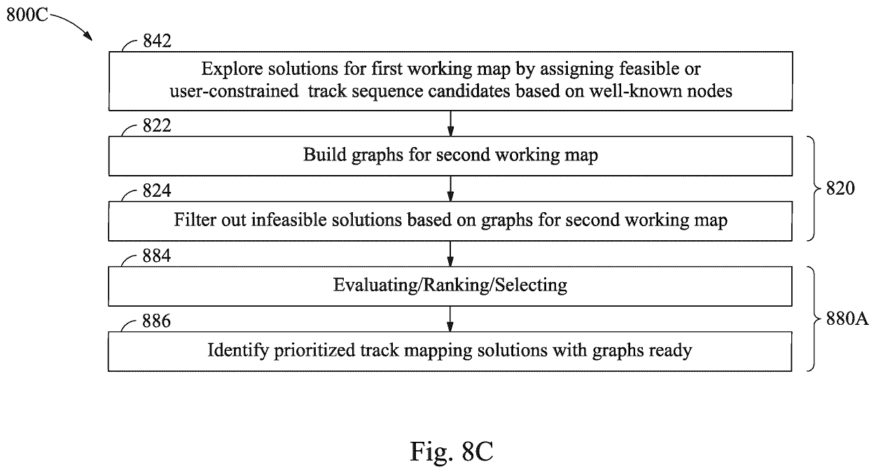

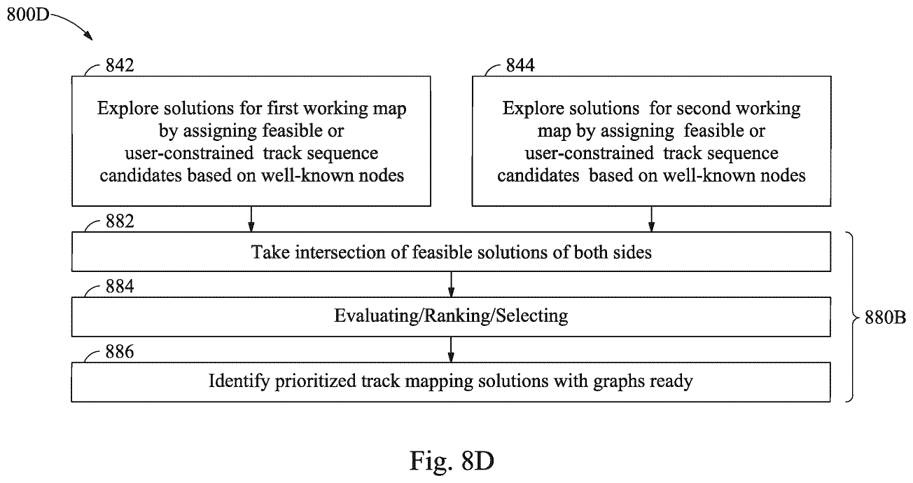

FIGS. 8A-8D are flow charts of different process flow examples for identifying track mapping solutions, in accordance with some embodiments.

FIG. 8A is a flow chart of a first process flow example 800A for identifying track mapping solutions based on a minimal exploring method, in accordance with some embodiments. In some embodiments, the flow chart in FIG. 8A corresponds to stage 522 and stage 540 in FIG. 5. In some embodiments, process flow 800A includes stages 810 and 820 corresponding to stage 522, and stage 880A corresponding to stage 540. In some embodiments, process flow 800A includes additional stages not included in FIG. 8A. In some implementations, one or more stages in FIG. 8A are simplified, modified, or omitted.

In FIG. 8A, process flow 800A begins at stage 810, which further includes stages 812, 814, and 816. In some embodiments, as discussed in connection with FIG. 5 at stage 510, two working maps (e.g., first working map 610 and second working map 620 in FIG. 6A) were identified based on the node map of the routing task, where a first working map corresponds to routing nodes with a smaller pitch or routing resource between two adjacent routing nodes, and a second working map corresponds to routing nodes with a greater pitch or routing resource between two adjacent routing nodes.

At stage 812, possible track mapping solutions for the first working map are determined by a selected track mapping algorithm based on one or more examples in FIG. 7B, 7D, or 7F. At stage 814, partial track mapping graphs for the first working map are built. At stage 816, infeasible solutions among the possible track mapping solutions from stage 812 are filtered out based on the partial track mapping graphs for the first working map from stage 814.

After stage 810, process flow 800A proceeds to stage 820, which further includes stages 822 and 824. At stage 822, partial track mapping graphs for the second working map are built. At stage 824, infeasible solutions among the filtered track mapping solutions from stage 816 are further filtered out based on the partial track mapping graphs for the second working map from stage 824.

After stage 820, process flow 800A proceeds to stage 880A, which further includes stages 884 and 886. At stage 884, the filtered feasible track mapping solutions from stage 824 are further evaluated, ranked, or selected based on one or more requests or criteria imposed by a designer. At stage 886, a track mapping graph is determined together with one or more mapping solutions identified and prioritized based on the results from stage 884.

FIG. 8B is a flow chart of a second process flow example 800B for identifying track mapping solutions based on a parallel exploring method, in accordance with some embodiments. In some embodiments, the flow chart in FIG. 8B corresponds to stage 526 and stage 540 in FIG. 5. In some embodiments, process flow 800B includes stages 810 and 830 corresponding to stage 526, and stage 880B corresponding to stage 540. In some embodiments, process flow 800B includes additional stages not included in FIG. 8B. In some implementations, one or more stages in FIG. 8B are simplified, modified, or omitted.

In FIG. 8B, process flow 800B begins at stage 810 and stage 830. In some embodiments, as discussed in connection with FIG. 5 at stage 510, two working maps (e.g., first working map 610 and second working map 620 in FIG. 6A) were identified based on the node map of the routing task, where a first working map corresponds to routing nodes with a smaller pitch or routing resource between two adjacent routing nodes, and a second working map corresponds to routing nodes with a greater pitch or routing resource between two adjacent routing nodes. Stage 810 corresponds to stage 810 in FIG. 8A, and detailed description is thus omitted. Stage 830 further includes stages 832, 834, and 836.

At stage 832, possible track mapping solutions for the second working map are determined by a selected track mapping algorithm based on one or more of the examples in FIG. 7B, 7D, or 7F. At stage 834, partial track mapping graphs for the second working map are built. At stage 836, infeasible solutions among the possible track mapping solutions from stage 832 are filtered out based on the partial track mapping graphs for the second working map from stage 834.

After stage 810 and stage 830, process flow 800B proceeds to stage 880B, which further includes stages 882, 884, and 886. At stage 882, the intersection of the feasible track mapping solutions from stage 810 and the feasible track mapping solutions from stage 830 are identified. At stage 884, the intersection of feasible track mapping solutions from stage 882 are further evaluated, ranked, or selected based on one or more requests or criteria imposed by a designer. At stage 886, a track mapping graph is determined together with one or more mapping solutions identified and prioritized based on the results from stage 884.

FIG. 8C is a flow chart of a third process flow example 800C for identifying track mapping solutions based on a single-side forecasting method, in accordance with some embodiments. In some embodiments, the flow chart in FIG. 8C corresponds to stage 532 and stage 540 in FIG. 5. In some embodiments, process flow 800C includes stages 842 and 820 corresponding to stage 532, and stage 880A corresponding to stage 540. In some embodiments, process flow 800C includes additional stages not included in FIG. 8C. In some implementations, one or more stages in FIG. 8C are simplified, modified, or omitted.

In FIG. 8C, process flow 800C begins at stage 842. In some embodiments, as discussed in connection with FIG. 5 at stage 510, two working maps (e.g., first working map 610 and second working map 620 in FIG. 6A) were identified based on the node map of the routing task, where a first working map corresponds to routing nodes with a smaller pitch or routing resource between two adjacent routing nodes, and a second working map corresponds to routing nodes with a greater pitch or routing resource between two adjacent routing nodes.

At stage 842, possible track mapping solutions for the first working map are determined by assigning feasible or user-constrained track sequence candidates based on well-known nodes (i.e., neighboring nodes having known or given track sequence assignments). In some embodiments, the feasibility or the constraints applicable at stage 842 include routing recourse capacity derived based on various design rules, limitations imposed by a designer, a combination thereof, or the like. In some embodiments, the partial track mapping graphs for the first working map are built while exploring the feasible or user-constrained track sequence candidates.

After stage 842, process flow 800C proceeds to stage 820 that corresponds to stage 820 in FIG. 8A. After stage 820, process flow 800C proceeds to stage 880A that corresponds to stage 880A in FIG. 8A.

FIG. 8D is a flow chart of a fourth process flow example 800D for determining possible track mapping solutions based on a parallel exploring method, in accordance with some embodiments. In some embodiments, the flow chart in FIG. 8D corresponds to stage 536 and stage 540 in FIG. 5. In some embodiments, process flow 800D includes stages 842 and 844 corresponding to stage 536, and stage 880B corresponding to stage 540. In some embodiments, process flow 800D includes additional stages not included in FIG. 8D. In some implementations, one or more stages in FIG. 8D are simplified, modified, or omitted.

In FIG. 8D, process flow 800D begins at stage 842 and stage 844. In some embodiments, as discussed in connection with FIG. 5 at stage 510, two working maps (e.g., first working map 610 and second working map 620 in FIG. 6A) were identified based on the node map of the routing task, where a first working map corresponds to routing nodes with a smaller pitch or routing resource between two adjacent routing nodes, and a second working map corresponds to routing nodes with a greater pitch or routing resource between two adjacent routing nodes. Stage 842 corresponds to stage 842 in FIG. 8C, and a detailed description is thus omitted.

At stage 844, possible track mapping solutions for the second working map are determined by assigning feasible or user-constrained track sequence candidates based on well-known nodes (i.e., neighboring nodes having known or given track sequence assignments). In some embodiments, the feasibility or the constraints applicable at stage 844 include routing recourse capacity derived based on various design rules, limitations imposed by a designer, a combination thereof, or the like. In some embodiments, the partial track mapping graphs for the second working map are built while exploring the feasible or user-constrained track sequence candidates.

After stage 842 and stage 844, process flow 800D proceeds to stage 880B that corresponds to stage 880B in FIG. 8B.

FIG. 9A is a flow chart of a process flow example 900 for imposing one or more modifications to ensure the presence of at least one feasible track mapping solution, in accordance with some embodiments. In some embodiments, the flow chart in FIG. 9A corresponds to modifying any of the examples in FIGS. 8A-8D based on stage 330 in FIG. 3. The flow chart in FIG. 9A includes stages 920, 930, and 880A of process flow 900. In some embodiments, process flow 900 includes additional stages not included in FIG. 9A. In some implementations, one or more stages in FIG. 9A are simplified, modified, or omitted.

In FIG. 9A, process flow 900 begins at stage 920 based on the results from stage 322 or stage 326 in FIG. 3, stage 924 in FIG. 9A, stage 982 in FIG. 9B, stage 924 in FIG. 9C, or stage 982 in FIG. 9D as indicated by block 910. At stage 920, whether the results from block 910 include at least one feasible solution is determined. In response to a decision that there is no feasible track mapping solution, the process proceeds to stage 930 (the “NO” branch). In response to a decision that there is at least one feasible track mapping solution, the process proceeds to stage 884 of stage 880A (the “YES” branch). In some embodiments, stage 880A corresponds to stage 880A in FIG. 8A and FIG. 8C or a portion of stage 880B in FIG. 8B and FIG. 8D. In some embodiments, stage 920 is modified to determine if the feasible solutions (if any) still fail within some user-defined criteria for further optimization, such that taking the “NO” branch for further modification is still justifiable in order to improve the final routing results.

At stage 930, one or more modifications are imposed on the track sequence information, the node map, or both, for modifying one or more failed solutions. After stage 930, process flow 800 proceeds to stage 886 that corresponds to stage 886 in FIGS. 8A-8D.

FIGS. 9B-9D are diagrams of node map examples 940A-940C with corresponding track mapping solutions, in accordance with some embodiments.

In FIG. 9B, node map 940A is a portion of a routing task and includes eight (8) circles representing eight (8) routing nodes 951-958. In some embodiments, node map 940A corresponds to the result from block 910 in FIG. 9A. In FIG. 9B, each one of the routing nodes is given a corresponding track sequence index. In FIG. 9B, track sequence indexes t1, t2, t3, t5, t7, 8, t10, and t11 are assigned to routing nodes 851-858, respectively. In FIG. 9B, the numbers on the edges represent the number of traces the edges accommodate in the worst-case scenario based on the track sequence information.

In this example, the pitch between adjacent routing nodes and/or design rules imposes a constraint that an edge between adjacent routing nodes (e.g., between nodes 951 and 952, 952 and 953, 953 and 955, 955 and 958, 958 and 957, 957 and 956, 956 and 954, and 954 and 951) is configured to accommodate two traces (i.e., two track sequence indexes). In some embodiments, such constraint corresponds to a design that cannot be physically implemented, or a design that can be physically implemented but is not preferred (e.g., congestion leading to thermal considerations). However, in FIG. 9B as a non-limiting example, there is a risk that the edge between nodes 951 and 954 would accommodate more than two traces (e.g., corresponding to three track sequence indexes t2, t3, and t4 in this non-limiting example). As such, node map 940A and the corresponding track sequence information indicate a non-feasible track mapping solution.

FIG. 9C includes node map 940B that represents imposing a first modification on node map 940A as a non-limiting example. Components in FIG. 9C that are the same or similar to those in FIG. 9B are given the same reference numbers, and the description thereof is thus simplified or omitted. In FIG. 9C, the numbers on the edges represent the number of traces the edges accommodate in the worst-case scenario based on the track sequence information. In FIG. 9C, the location of routing node 951 is moved further away from routing node 954, such that the edge between routing node 951 and routing node 954 is capable of accommodating three traces (i.e., three track sequence indexes).

FIG. 9D includes node map 940C that represents imposing a second modification to node map 940A as a non-limiting example. Components in FIG. 9D that are the same or similar to those in FIG. 9B are given the same reference numbers, and the description thereof is thus simplified or omitted. In FIG. 9D, the numbers on the edges represent the number of traces the edges accommodate in the worst-case scenario based on the track sequence information. In FIG. 9D, the assigned track sequence indexes of routing node 951 and routing node 952 are swapped, such that the number of traces the edge between routing node 951 and routing node 952 would accommodate in the worst-case scenario is reduced to two (2) without exceeding the constraint based on the pitch between adjacent routing nodes and/or design rules.

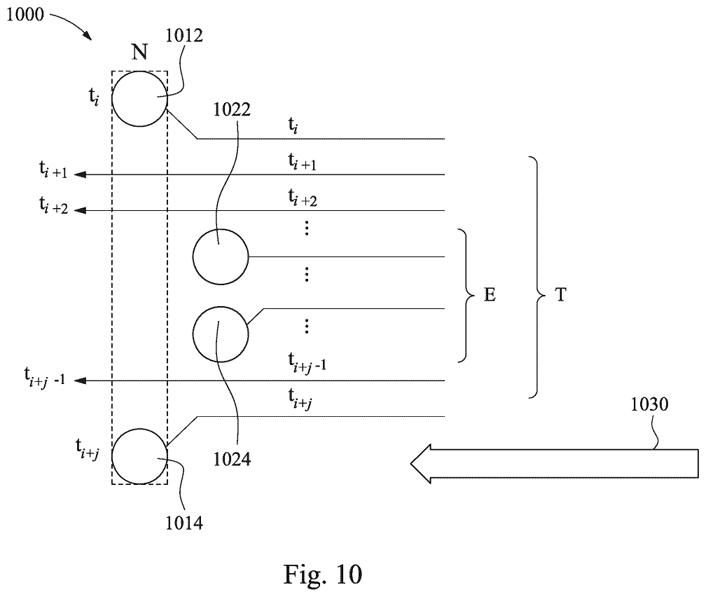

FIG. 10 is a diagram of a routing example 1000 based on a monotonic routing process, in accordance with some embodiments. Routing example 1000 is a simplified example, and various components thereof are simplified or omitted in FIG. 10. In some embodiments, the monotonic routing process, the track sequence indexes between any two nodes are fixed and derivable, and the trace count between any two nodes is also fixed and derivable. As such, in some embodiments based on the monotonic routing process, traces between any two nodes are predictable without ambiguity.

In FIG. 10, routing example 1000 includes routing nodes (represented by circles), such as routing nodes 1012, 1014, 1022, and 1024. Routing example 1000 includes possible traces to be determined based on a propagating direction 1030 and are associated with corresponding track sequence indexes ti, ti+1, ti+2, . . . , ti+j−1, and ti+j. In this non-limiting example, routing node 1012 and routing node 1014 are associated with track sequence indexes ti and ti+j. In FIG. 10, N represents an area where routing node 1012 and routing node 1014 are located. In FIG. 10, T represents a set of track sequence indexes tx, where i<x<i+j. In FIG. 10, E represents a set of track sequence indexes that is a subset of T and also associated with routing nodes (e.g., routing nodes 1022 and 1024) that are located before area N along propagating direction 1030. In some embodiments, the monotonic routing process is performed based on a constraint that traces associated with track sequence indexes of {T-E} are arranged to pass through area N.

FIG. 11A is a diagram of a node map example 1100A with edges between adjacent nodes, in accordance with some embodiments. Node map example 1100A includes routing nodes 1111~1118 and two virtual routing boundaries 1122 and 1124. In FIG. 11A, node map example 1100A includes routing edges (represented by dashed lines) between routing nodes 1111 and 1112, routing nodes 1112 and 1113, routing nodes 1113 and 1115, routing nodes 1115 and 1118, routing nodes 1118 and 1117, routing nodes 1117 and 1116, routing nodes 1116 and 1114, routing nodes 1111 and 1114, routing nodes 1112 and 1115, routing nodes 1112 and 1116, routing nodes 1117 and 1115, and routing nodes 1117 and 1116. In FIG. 11A, node map example 1100A further includes routing edges (represented by dashed lines) between virtual routing boundary 1122 and routing nodes 1111, 1112, and 1113, and between virtual routing boundary 1124 and routing nodes 1116, 1117, and 1118. In some embodiments, the routing edges in FIG. 11A are referred to as “fundamental edges” corresponding to routing edges between neighboring routing nodes and virtual routing boundaries.

FIG. 11B is a diagram of a node map example 1100B with edges between adjacent nodes, in accordance with some embodiments. Components in FIG. 11B that are the same or similar to those in FIG. 11A are given the same reference numbers, and the description thereof is thus simplified or omitted. In FIG. 11B, node map example 1100B includes edges (represented by dashed lines) between all combinations of two of routing nodes 1111~1118 regardless of the locations thereof. In some embodiments, the routing edges in FIG. 11B are referred to as “all potential edges,” and “fundamental edges” is a subset of “all potential edges.”

In some embodiments, a track mapping graph described above is based on a node map of a routing task and routing edges defined based on routing nodes and two virtual routing boundaries of the node map. In some embodiments, the routing edges are usable for guiding routing paths and for checking capacity as discussed above. In some embodiments, the defined routing edges do not cross one another. In some embodiments, the routing edges cover all potential routing bottlenecks. In some embodiments, a small number of routing edges (e.g., “fundamental edges” in FIG. 11A) increases the uncertainty or inaccuracy of the resulting track mapping graph with the edge attributes and increases the risk of capacity failure (e.g., a space between two nodes being inadvertently arranged to accommodate traces more than the capacity allowed by the design rules or designer's constraints). In some embodiments, an excessive number of routing edges (e.g., “all potential edges” in FIG. 11B) increases the computational complexity for obtaining the edge attributes and increases the chance of misleading the routing process.

Accordingly, in some embodiments, the routing edges for a routing task include at least the “fundamental edges” as in FIG. 11A and one or more “extra edges” that are within the “all potential edges” as in FIG. 11B but not the “fundamental edges.” In some embodiments, the “fundamental edges” are usable for guiding routing paths and checking the capacity of edges. In some embodiments, the “extra edges” correspond to bottlenecks of the routing task and are usable for checking the capacity of the bottleneck edges in addition to the “fundamental edges.” In some embodiments, the combination of “fundamental edges” and “extra edges” reduces the edge count in a routing task while also reduces the risk of capacity failure.

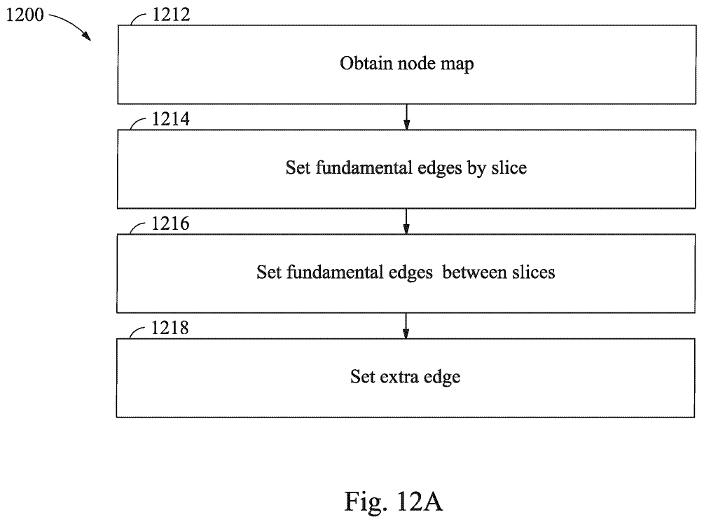

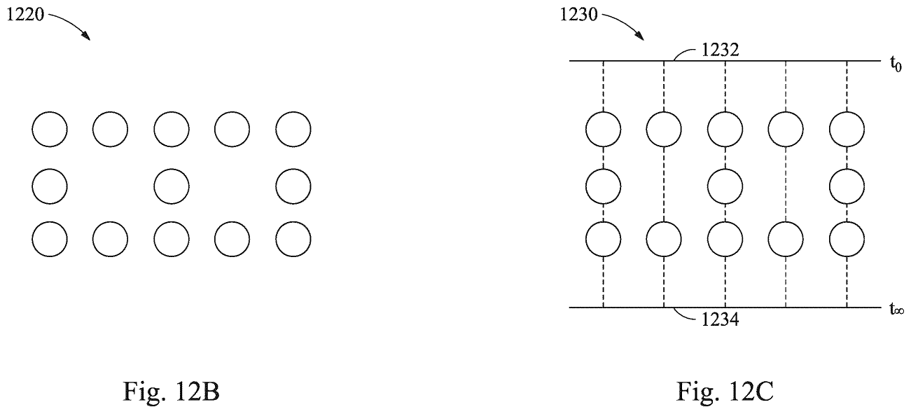

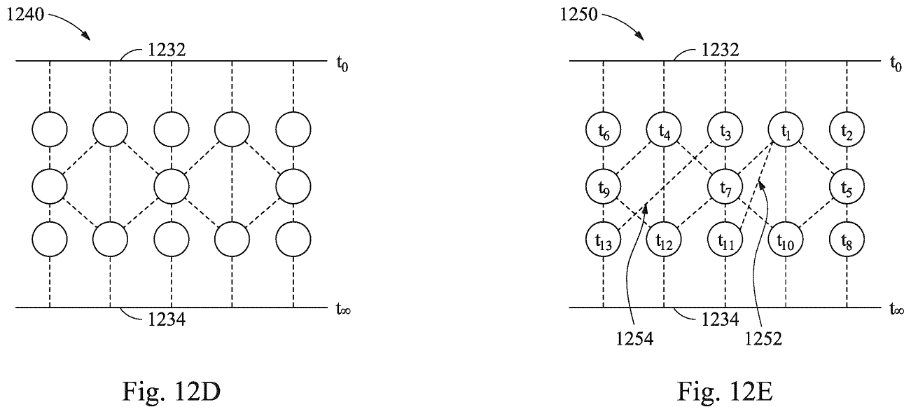

FIG. 12A is a flow chart of a process flow example 1200 for setting up routing edges, in accordance with some embodiments. The flow chart in FIG. 12A includes stages 1212-1218 of process flow 1200. In some embodiments, process flow 1200 includes additional stages not included in FIG. 12A. In some embodiments, process flow 1200 is part of stage 324 or stage 326 in FIG. 3 and stage 430 in FIG. 4.

In FIG. 12A, process flow example 1200 starts at stage 1212, where a node map is obtained. At stage 1214, the nodes are grouped into slices of nodes along corresponding reference lines connecting virtual routing boundaries and traversing (e.g., perpendicular to) a propagating direction of traces. At stage 1214, a first set of fundamental edges between routing nodes within individual slices and between routing nodes and the virtual routing boundaries are set. At stage 1216, a second set of fundamental edges between adjacent slices of routing nodes are set. In some embodiments, the fundamental edges between adjacent slices of routing nodes are set based on a criteria-based method. In some embodiments, the criteria-based method is based on adjacent nodes having an edge length less than a reference distance (e.g., a pitch less than a threshold). In some embodiments, the fundamental edges between routing nodes are set based on a triangulation-based method, such as a Delaunay triangulation process.

At stage 1218, extra edges are set. In some embodiments, the extra edges are set based on a capacity-based method. For example, in response to a possible number of traces passing between two routing nodes being greater than a capacity (e.g., calculated based on a monotonic routing theorem) between the two routing nodes, an extra routing edge is set between these two routing nodes. In some embodiments, the extra edges are set based on a route-based method. For example, for three routing nodes defining a triangle, the longest side of the triangle is set as an extra edge provided certain conditions are met.

FIGS. 12B-12E are diagrams of node map examples at different stages of the flow chart in FIG. 12A, in accordance with some embodiments. In FIG. 12B, a node map 1220 indicates the node map obtained at stage 1212 in FIG. 12A, where the circles represent the routing nodes of the node map 1220. In FIG. 12C, a node map 1230 is derived based on node map 1220, with the inclusion of a first set of fundamental routing edges (represented by dashed lines) between nodes within individual slices and between nodes and virtual routing boundaries 1232 and 1234 obtained at stage 1214 in FIG. 12A. In FIG. 12D, a node map 1240 is derived based on node map 1230, with the inclusion of a second set of fundamental routing edges between nodes of adjacent slices obtained at stage 1216 in FIG. 12A.

In FIG. 12E, a node map 1250 is derived based on node map 1240, with the inclusion of at least one extra edge (e.g., extra edge 1252 and extra edge 1254) added at stage 1218 in FIG. 12A. In FIG. 12E, the routing nodes are also associated with corresponding tracking sequence indexes t1-t13. In some embodiments, one or more extra edges are set up between pairs of the first plurality of routing nodes, in response to the extra edges having insufficient routing capacities or meeting one or more selection criteria based on geometric arrangements of corresponding track sequence indexes.

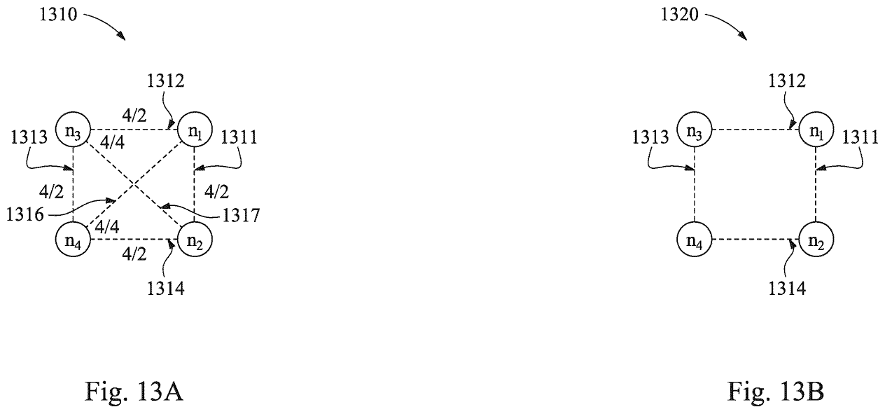

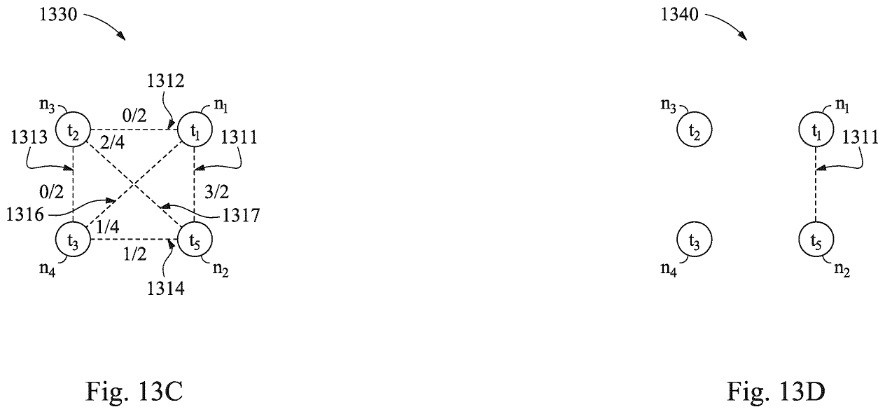

FIGS. 13A-13B are diagrams of node map examples for determining an extra edge based on a first capacity-based method, in accordance with some embodiments. In FIG. 13A, a node map 1310 includes routing nodes (represented by circles) n1, n2, n3, and n4 as a non-limiting example. Node map 1310 further includes extra edge candidates 1311, 1312, 1313, 1314, 1316, and 1317 between various nodes. In this non-limiting example, given the locations of the routing nodes n1, n2, n3, and n4, a capacity of all edge candidates is determined. Also, a total trace count is determined. In this non-limiting example, each one of extra edge candidates 1311, 1312, 1313, and 1314 has a total trace count 4 and a capacity 2 (marked as “4/2”), and each one of extra edge candidates 1316 and 1317 has a total trace count 4 and a capacity 4 (marked as “4/4”).

In some embodiments, based on the first capacity-based method, an extra edge candidate is set as an extra edge in response to the total trace count of that edge candidate is greater than the capacity of that edge candidate. In FIG. 13B, a node map 1320 includes routing nodes (represented by circles) n1, n2, n3, and n4. Compared to node map 1310 in FIG. 13A, node map 1320 in FIG. 13B indicates that extra edge candidates 1311, 1312, 1313, and 1314 are set as extra edges, and extra edge candidates 1316 and 1317 are not set as extra edges, based on the first capacity-based method.

FIGS. 13C-13D are diagrams of node map examples for determining an extra edge based on a second capacity-based method, in accordance with some embodiments. In FIG. 13C, a node map 1330 includes routing nodes (represented by circles) n1, n2, n3, and n4 associated with track mapping indexes t1, t5, t2, and t3 as a non-limiting example. Node map 1330 further includes extra edge candidates 1311, 1312, 1313, 1314, 1316, and 1317 between various nodes. In this non-limiting example, given the track sequence information of the routing nodes, allowed passing trace counts of all edge candidates are calculated. In some embodiments, in response to an allowed passing trace count exceeding the capacity of an edge candidate, the edge candidate is set as an extra edge. In this non-limiting example, extra edge candidate 1311 has a total trace count 3 and a capacity 2 (marked as “3/2”); extra edge candidate 1312 has a total trace count 0 and a capacity 2 (marked as “0/2”); extra edge candidate 1313 has a total trace count 0 and a capacity 2 (marked as “0/2”); extra edge candidate 1314 has a total trace count 1 and a capacity 2 (marked as “1/2”); extra edge candidate 1316 has a total trace count 1 and a capacity 4 (marked as “1/4”); and extra edge candidate 1317 has a total trace count 2 and a capacity 4 (marked as “2/4”).

In some embodiments, based on the second capacity-based method, an extra edge candidate is set as an extra edge in response to the total trace count of that edge candidate being greater than the capacity of that edge candidate. In FIG. 13D, a node map 1340 includes routing nodes (represented by circles) n1, n2, n3, and n4. Compared to node map 1330 in FIG. 13C, node map 1340 in FIG. 13D indicates that extra edge candidate 1311 is set as an extra edge, and the other extra edge candidates are not set as extra edges, based on the second capacity-based method.

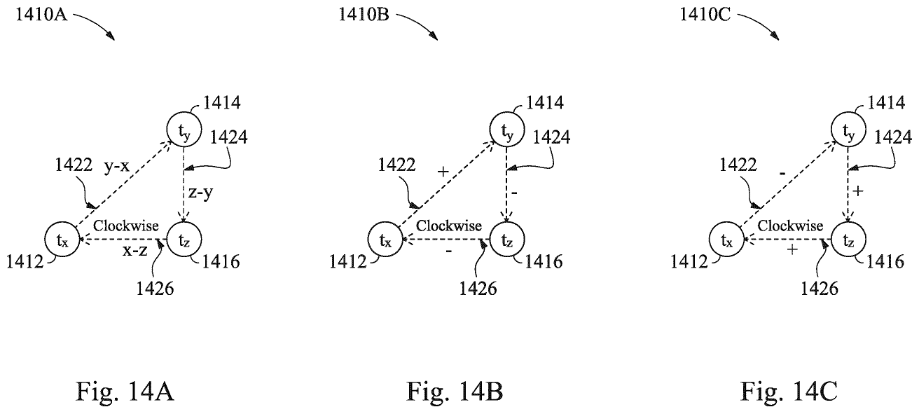

FIGS. 14A-14C are diagrams of node map examples for determining an extra edge based on a route-based method, in accordance with some embodiments. In FIG. 14A, a node map 1410A includes three routing nodes 1412, 1414, and 1416 associated with track sequence indexes tx, ty, and tz. Node map 1410A further includes an extra edge candidate 1422 between routing nodes 1412 and 1414, an extra edge candidate 1422 between routing nodes 1414 and 1416, and an extra edge candidate 1426 between routing nodes 1416 and 1412.

In some embodiments, the route-based method is based on a monotonic routing theorem for path prediction. In some embodiments, given the track sequence information of the routing nodes, how the traces pass through the sides of a triangle formed by the extra edge candidates is determined. In some embodiments, an extra edge candidate is considered as a risky edge and to be set as an extra edge in a scenario that the longest side of the triangle collects all traces from the other two sides.

In FIG. 14A, in some embodiments, a quick approach of checking if a longest side is risky is based on calculating the sign of the ordinal difference of the track sequence indexes. For example, an ordinal difference associated with extra edge candidate 1422 is based on y-x; an ordinal difference associated with extra edge candidate 1424 is based on z-y; and an ordinal difference associated with extra edge candidate 1426 is based on x-z.

In FIG. 14B, node map 1410B according to this example is based on node map 1410A and has the signs of the ordinal differences associated with extra edge candidates 1422, 1424, and 1426 being positive, negative, and negative. That is track sequence indexes tx, ty, and tz have a relationship of x<z<y. In this example, extra edge candidate 1422 will collect all the traces from extra edge candidates 1424 and 1426 and thus is set to be an extra edge.

In FIG. 14C, node map 1410C according to this example is based on node map 1410A and has the signs of the ordinal differences associated with extra edge candidates 1422, 1424, and 1426 being negative, positive, and positive. That is track sequence indexes tx, ty, and tz have a relationship of y<z<x. In this example, extra edge candidate 1422 will collect all the traces from extra edge candidates 1424 and 1426 and thus is set to be an extra edge.

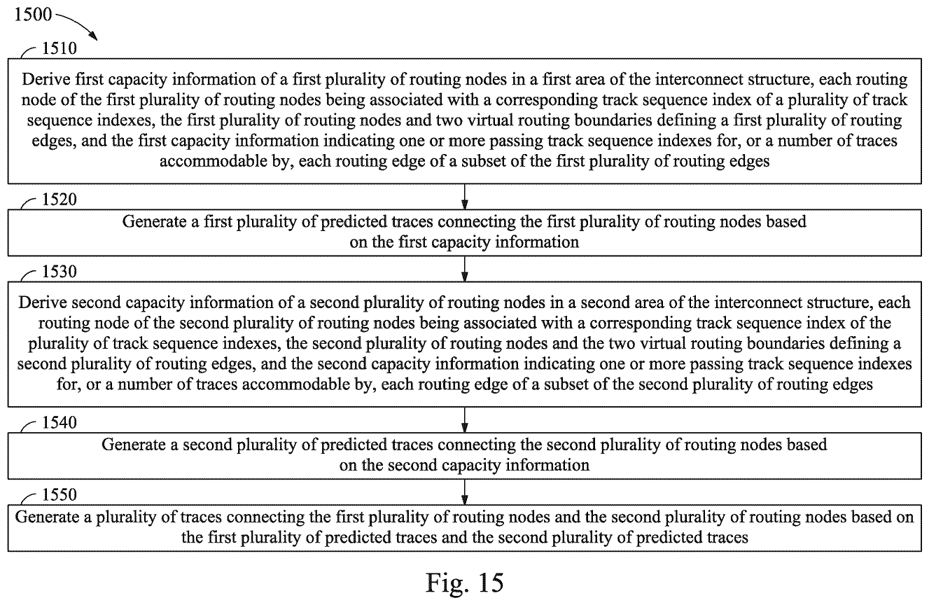

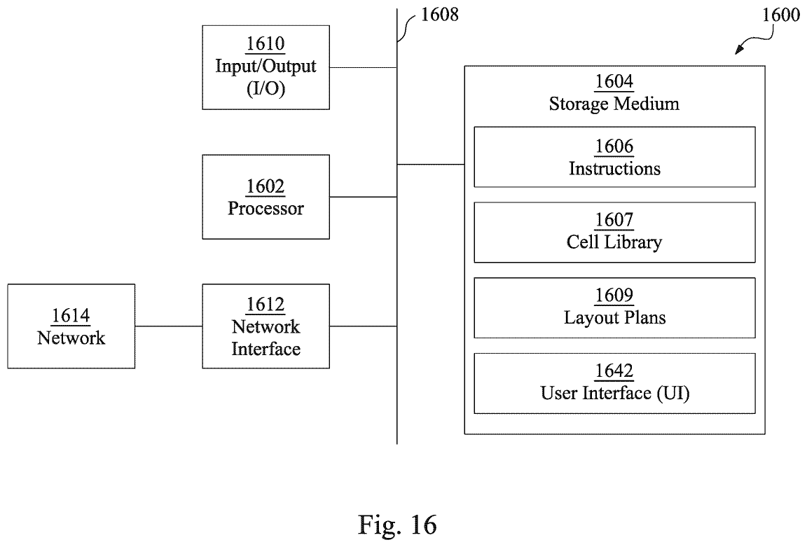

FIG. 15 is a flowchart of method 1500 of routing traces of an interconnect structure, in accordance with some embodiments. In some embodiments, various operations of method 1500 are based on a combination of the examples in FIGS. 2-14C. In some embodiments, various operations of method 1500 are performed by an EDA system as discussed with respect to the EDA system in FIG. 16. Method 1500 includes blocks 1510-1550.

At block 1510, first capacity information of a first plurality of routing nodes (e.g., first plurality of routing nodes 212 in FIG. 2 and FIG. 6A) in a first area (e.g., first area 214 in FIG. 2) of the interconnect structure (e.g., interconnect structure 210 in FIG. 2) is derived. In some embodiments, each routing node of the first plurality of routing nodes is associated with a corresponding track sequence index of a plurality of track sequence indexes (e.g., track sequence indexes t1-t13 in FIG. 6A). In some embodiments, the first plurality of routing nodes and two virtual routing boundaries (e.g., virtual routing boundaries 612 and 614) define a first plurality of routing edges (e.g., dotted lines in FIG. 6D). In some embodiments, the first capacity information (e.g., text remarks associated with routing edges in FIG. 6D) indicates one or more passing track sequence indexes for, and/or a number of traces accommodable by, each routing edge of a subset of the first plurality of routing edges. In some embodiments, block 1510 corresponds to stage 324 or stage 326 in FIG. 3 based on working map 610 in FIG. 6A.

At block 1520, a first plurality of predicted traces (e.g., predicted traces 652, 654, 656, and 658 in FIG. 6E) connecting the first plurality of routing nodes is generated based on the first capacity information. In some embodiments, block 1520 corresponds to stage 350 in FIG. 3 based on working map 620 in FIG. 6A.

At block 1530, second capacity information of a second plurality of routing nodes (e.g., first plurality of routing nodes 222 in FIG. 2 and FIG. 6A) in a second area (e.g., second area 224 in FIG. 2) of the interconnect structure (e.g., interconnect structure 210 in FIG. 2) is derived. In some embodiments, each routing node of the second plurality of routing nodes is associated with a corresponding track sequence index of a plurality of track sequence indexes (e.g., track sequence indexes t1-t13 in FIG. 6A). In some embodiments, the second plurality of routing nodes and two virtual routing boundaries define a second plurality of routing edges (e.g., in a manner similar to the example regarding second plurality of routing nodes in FIG. 6D). In some embodiments, the second capacity information indicates one or more passing track sequence indexes for, and/or a number of traces accommodable by, each routing edge of a subset of the second plurality of routing edges. In some embodiments, block 1530 corresponds to stage 324 or stage 326 in FIG. 3 based on working map 620 in FIG. 6A.

At block 1540, a second plurality of predicted traces (e.g., predicted traces 662, 664, 666, and 668 in FIG. 6F) connecting the second plurality of routing nodes is generated based on the second capacity information. In some embodiments, block 1540 corresponds to stage 350 in FIG. 3 based on working map 620 in FIG. 6A.

At block 1550, a plurality of traces (e.g., the traces in FIG. 6F) connecting the first plurality of routing nodes and the second plurality of routing nodes is generated based on the first plurality of predicted traces and the second plurality of predicted traces.

In some embodiments, the first plurality of predicted traces is monotonic with respect to a propagating direction between the first area and the second area, band-bounding with respect to first one or more bands of the first plurality of routing nodes defined based on the propagating direction, or cross-free with respect to the propagating direction. In some embodiments, the second plurality of predicted traces is monotonic with respect to the propagating direction, band-bounding with respect to second one or more bands of the second plurality of routing nodes defined based on the propagating direction, or cross-free with respect to the propagating direction.

In some embodiments, method 1500 includes identifying the first plurality of routing nodes that corresponds to first bumps or first via structures of the interconnect structure, and identifying the second plurality of routing nodes that corresponds to second bumps or second via structures of the interconnect structure.

In some embodiments, the generating the first plurality of predicted traces is based on identities of passing track sequence indexes in association with corresponding ones of the first plurality of routing edges and/or the number of traces accommodable by the corresponding ones of the first plurality of routing edges included in the first capacity information, as illustrated by the examples of FIG. 3 at stage 344 or stage 346. In some embodiments, the generating the second plurality of predicted traces is based on identities of passing track sequence indexes in association with corresponding ones of the second plurality of routing edges and/or the number of traces accommodable by the corresponding ones of the second plurality of routing edges included in the second capacity information, as illustrated by the examples of FIG. 3 at stage 344 or stage 346.

In some embodiments, method 1500 includes assigning the plurality of track sequence indexes to the first plurality of routing nodes and the second plurality of routing nodes based on a propagating direction between the first area and the second area, locations of the first plurality of routing nodes, and locations of the second plurality of routing nodes. In some embodiments, the plurality of track sequence indexes is assigned based on the examples of FIG. 4 at stages 410-420 and/or FIG. 5 at stage 510.

In some embodiments, method 1500 includes assigning a beginning track sequence index corresponding to an ordinal position before the plurality of track sequence indexes and assigning an ending track sequence index corresponding to an ordinal position after the plurality of track sequence indexes to the two virtual routing boundaries, as illustrated by the example in FIG. 6B. in some embodiments, method 1500 includes setting up routing edges, where each one of the routing edges connects two routing nodes of the first plurality of routing nodes, two routing nodes of the second plurality of routing nodes, one of the two virtual routing boundaries and one routing node of the first plurality of routing nodes, or the one of the two virtual routing boundaries and one routing node of the second plurality of routing node, as illustrated by the example in FIG. 6C.

In some embodiments, method 1500 includes setting up a first set of fundamental edges between adjacent routing nodes and between routing nodes and boundaries within individual slices based on a first graph of the first plurality of routing nodes, and setting up a second set of fundamental edges between routing nodes of adjacent slices, as illustrated by the example in FIG. 12D. In some embodiments, the setting up the first set of fundamental edges is based on an edge length less than a reference distance. In some embodiments, the setting up the second set of fundamental edges is based on a Delaunay triangulation process. In some embodiments, method 1500 further includes setting up extra edges between pairs of the first plurality of routing nodes, in response to the extra edges having insufficient routing capacities or meeting one or more selection criteria based on geometric arrangements of corresponding track sequence indexes, as illustrated by the example in FIG. 12E.

In some embodiments, as illustrated by the example in FIG. 8A, method 1500 includes deriving a first set of possible track mapping solutions of the first plurality of routing nodes based on a first graph of the first plurality of routing nodes (e.g., stage 810 in FIG. 8A) and determining a set of feasible track mapping solutions between the first plurality of routing nodes and the second plurality of routing nodes based on the first set of possible track mapping solutions and a second graph of the second plurality of routing nodes (e.g., stage 820 in FIG. 8A). In some embodiments, method 1500 includes determining a track mapping graph and identifying one or more track mapping solutions based on the set of feasible track mapping solutions (e.g., stage 880A in FIG. 8A).

In some embodiments, as illustrated by the example in FIG. 8B, method 1500 includes deriving a first set of possible track mapping solutions of the first plurality of routing nodes based on a first graph of the first plurality of routing nodes (e.g., stage 810 in FIG. 8B), deriving a second set of possible track mapping solutions of the second plurality of routing nodes based on a second graph of the second plurality of routing nodes (e.g., stage 830 in FIG. 8B), and determining a set of feasible track mapping solutions between the first plurality of routing nodes and the second plurality of routing nodes based on the first set of possible track mapping solutions and the second set of possible track mapping solutions (e.g., stage 882 in FIG. 8B). In some embodiments, method 1500 includes determining a track mapping graph and identifying one or more track mapping solutions based on the set of feasible track mapping solutions (e.g., stages 882 and 884 in FIG. 8B).

In some embodiments, as illustrated by the example in FIG. 8C, method 1500 includes obtaining a first set of possible track mapping solutions of the first plurality of routing nodes (e.g., stage 842 in FIG. 8C) and determining a set of feasible track mapping solutions between the first plurality of routing nodes and the second plurality of routing nodes based on the first set of possible track mapping solutions and a second graph of the second plurality of routing nodes (e.g., stage 820 in FIG. 8C). In some embodiments, method 1500 includes determining a track mapping graph and identifying one or more track mapping solutions based on the set of feasible track mapping solutions (e.g., stage 880A in FIG. 8C).

In some embodiments, as illustrated by the example in FIG. 8D, method 1500 includes obtaining a first set of possible track mapping solutions of the first plurality of routing nodes (e.g., stage 842 in FIG. 8D), obtaining a second set of possible track mapping solutions of the second plurality of routing nodes (e.g., stage 844 in FIG. 8D), and determining a set of feasible track mapping solutions between the first plurality of routing nodes and the second plurality of routing nodes based on the first set of possible track mapping solutions and the second set of possible track mapping solutions (e.g., stage 882 in FIG. 8D). In some embodiments, method 1500 includes determining a track mapping graph and identifying one or more track mapping solutions based on the set of feasible routing solutions (e.g., stages 882 and 884 in FIG. 8D).

In some embodiments, as illustrated by the examples in FIGS. 9A-9D, method 1500 incudes determining presence or absence of at least one feasible track mapping solution between the first plurality of routing nodes and the second plurality of routing nodes (e.g., stage 920 in FIG. 9A). In some embodiments, method 1500 further includes, in response to a determination of absence of at least one feasible track mapping solution between the first plurality of routing nodes and the second plurality of routing nodes, a first graph of the first plurality of routing nodes or a second graph of the second plurality of routing nodes (e.g., stage 930 in FIG. 9A) for obtaining one or more modified track mapping solutions. In some embodiments, method 1500 further includes determining a track mapping graph and identifying one or more track mapping solutions based on at least the one or more modified track mapping solutions (e.g., stage 886 at FIG. 9A).

FIG. 16 is a block diagram of an electronic design automation (EDA) system 1600 in accordance with some embodiments. In some embodiments, EDA system 1600 includes an automatic placement and routing (APR) system. Methods described herein in accordance with one or more embodiments are implementable, for example, using EDA system 1600, in accordance with some embodiments.

In some embodiments, EDA system 1600 is a general-purpose computing device including a hardware processor 1602 and a computer-readable storage medium 1604. Storage medium 1604, amongst other things, is encoded with, i.e., stores, computer program code 1606, i.e., a set of executable instructions. Execution of instructions 1606 by hardware processor 1602 represents (at least in part) an EDA tool which implements a portion or all of the methods described herein in accordance with one or more embodiments (hereinafter, the noted processes and/or methods).

Processor 1602 is electrically coupled to computer-readable storage medium 1604 via a bus 1608. Processor 1602 is also electrically coupled to an I/O interface 1610 by bus 1608. A network interface 1612 is also electrically connected to processor 1602 via bus 1608. Network interface 1612 is connected to a network 1614, so that processor 1602 and computer-readable storage medium 1604 are capable of connecting to external elements via network 1614. Processor 1602 is configured to execute computer program code 1606 encoded in computer-readable storage medium 1604 in order to cause system 1600 to be usable for performing a portion or all of the noted processes and/or methods. In one or more embodiments, processor 1602 is a CPU, a multi-processor, a distributed processing system, an application specific integrated circuit (ASIC), and/or a suitable processing unit.

In one or more embodiments, computer-readable storage medium 1604 is a non-transitory computer-readable storage medium including an electronic, magnetic, optical, electromagnetic, infrared, and/or a semiconductor system (or apparatus or device). For example, computer-readable storage medium 1604 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 1604 includes a compact disk-read only memory (CD-ROM), a compact disk-read/write (CD-R/W), and/or a digital video disc (DVD).

In one or more embodiments, storage medium 1604 stores computer program code 1606 configured to cause system 1600 (where such execution represents (at least in part) the EDA tool) to be usable for performing a portion or all of the noted processes and/or methods. In one or more embodiments, storage medium 1604 also stores information which facilitates performing a portion or all of the noted processes and/or methods. In one or more embodiments, storage medium 1604 stores a cell library 1607 of standard cells including such standard cells as disclosed herein. In one or more embodiments, storage medium 1604 stores one or more layout plans 1609 corresponding to one or more layouts plans disclosed herein.

EDA system 1600 includes I/O interface 1610. I/O interface 1610 is coupled to external circuitry. In one or more embodiments, I/O interface 1610 includes a keyboard, keypad, mouse, trackball, trackpad, touchscreen, and/or cursor direction keys for communicating information and commands to processor 1602.

EDA system 1600 also includes network interface 1612 coupled to processor 1602. Network interface 1612 allows system 1600 to communicate with network 1614, to which one or more other computer systems are connected. Network interface 1612 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 1600.

System 1600 is configured to receive information through I/O interface 1610. The information received through I/O interface 1610 includes one or more of instructions, data, design rules, libraries of standard cells, and/or other parameters for processing by processor 1602. The information is transferred to processor 1602 via bus 1608. EDA system 1600 is configured to receive information related to a UI through I/O interface 1610. The information is stored in computer-readable medium 1604 as user interface (UI) 1642.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 1600. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some aspects, a method of routing traces of an interconnect structure includes deriving first capacity information of a first plurality of routing nodes in a first area of the interconnect structure and generating a first plurality of predicted traces connecting the first plurality of routing nodes based on the first capacity information. Each routing node of the first plurality of routing nodes is associated with a corresponding track sequence index of a plurality of track sequence indexes, the first plurality of routing nodes and two virtual routing boundaries define a first plurality of routing edges, and the first capacity information indicates one or more passing track sequence indexes for, or a number of traces accommodable by, each routing edge of a subset of the first plurality of routing edges. The method of routing traces of the interconnect structure includes deriving second capacity information of a second plurality of routing nodes in a second area of the interconnect structure, and generating a second plurality of predicted traces connecting the second plurality of routing nodes based on the second capacity information. Each routing node of the second plurality of routing nodes is associated with a corresponding track sequence index of the plurality of track sequence indexes, the second plurality of routing nodes and the two virtual routing boundaries define a second plurality of routing edges, and the second capacity information indicates one or more passing track sequence indexes for, or a number of traces accommodable by, each routing edge of a subset of the second plurality of routing edges. The method of routing traces of the interconnect structure further includes generating a plurality of traces connecting the first plurality of routing nodes and the second plurality of routing nodes based on the first plurality of predicted traces and the second plurality of predicted traces.

In some aspects, a processing device for routing traces of an interconnect structure includes a memory device and processing circuitry coupled to the memory device. The processing circuitry is configured to derive first capacity information of a first plurality of routing nodes in a first area of the interconnect structure, and to generate a first plurality of predicted traces connecting the first plurality of routing nodes based on the first capacity information. Each routing node of the first plurality of routing nodes is associated with a corresponding track sequence index of a plurality of track sequence indexes, the first plurality of routing nodes and two virtual routing boundaries define a first plurality of routing edges, and the first capacity information indicates one or more passing track sequence indexes, or a number of traces accommodable by, each routing edge of a subset of the first plurality of routing edges. The processing circuitry is configured to derive second capacity information of a second plurality of routing nodes in a second area of the interconnect structure, and to generate a second plurality of predicted traces connecting the second plurality of routing nodes based on the second capacity information. Each routing node of the second plurality of routing nodes is associated with a corresponding track sequence index of the plurality of track sequence indexes, the second plurality of routing nodes and the two virtual routing boundaries define a second plurality of routing edges, and the second capacity information indicates one or more passing track sequence indexes for, or a number of traces accommodable by, each routing edge of a subset of the second plurality of routing edges. The processing circuitry is further configured to generate a plurality of traces connecting the first plurality of routing nodes and the second plurality of routing nodes based on the first plurality of predicted traces and the second plurality of predicted traces.

In some aspects, a non-transitory computer-readable medium that stores instructions which, when executed by processing circuitry of a processing device, cause the processing device to derive first capacity information of a first plurality of routing nodes in a first area of an interconnect structure, and to generate a first plurality of predicted traces connecting the first plurality of routing nodes based on the first capacity information. Each routing node of the first plurality of routing nodes is associated with a corresponding track sequence index of a plurality of track sequence indexes, the first plurality of routing nodes and two virtual routing boundaries define a first plurality of routing edges, and the first capacity information indicates one or more passing track sequence indexes for, or a number of traces accommodable by, each routing edge of a subset of the first plurality of routing edges. The instructions, when executed by the processing circuitry of the processing device, cause the processing device to derive second capacity information of a second plurality of routing nodes in a second area of the interconnect structure, and to generate a second plurality of predicted traces connecting the second plurality of routing nodes based on the second capacity information. Each routing node of the second plurality of routing nodes is associated with a corresponding track sequence index of the plurality of track sequence indexes, the second plurality of routing nodes and the two virtual routing boundaries define a second plurality of routing edges, and the second capacity information indicates one or more passing track sequence indexes for, or a number of traces accommodable by, each routing edge of a subset of the second plurality of routing edges. The instructions, when executed by the processing circuitry of the processing device, cause the processing device to generate a plurality of traces of the interconnect structure connecting the first plurality of routing nodes and the second plurality of routing nodes based on the first plurality of predicted traces and the second plurality of predicted traces.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. A method of routing traces of an interconnect structure, comprising:
deriving respective capacity information for a first plurality of routing nodes in a first area of the interconnect structure and a second plurality of routing nodes in a second area of the interconnect structure, each routing node of the first and second pluralities of routing nodes being associated with a corresponding track sequence index of a plurality of track sequence indexes, the first and second pluralities of routing nodes together with two virtual routing boundaries defining respective first and second pluralities of routing edges, and the respective capacity information indicating, for individual routing edges of a subset of the respective first and second pluralities of routing edges, one or more passing track sequence indexes or a number of traces accommodable by the routing edge;
generating, based on the respective capacity information, a first plurality of predicted traces connecting the first plurality of routing nodes and a second plurality of predicted traces connecting the second plurality of routing nodes;
generating, based on the first plurality of predicted traces and the second plurality of predicted traces, a plurality of traces connecting the first plurality of routing nodes and the second plurality of routing nodes; and
storing the plurality of traces connecting the first plurality of routing nodes and the second plurality of routing nodes.

2. The method of claim 1, further comprising:
identifying the first and second pluralities of routing nodes as corresponding to respective first and second bumps or via structures of the interconnect structure.

3. The method of claim 1, wherein
the generating the first and second pluralities of predicted traces is further based on identities in association with corresponding ones of the respective first and second pluralities of routing edges, or the number of traces accommodable by the corresponding ones of the respective first and second pluralities of routing edges, included in the respective capacity information.

4. The method of claim 1, further comprising:
assigning the plurality of track sequence indexes to the first plurality of routing nodes and the second plurality of routing nodes based on a propagating direction between the first area and the second area, and respective locations of the first plurality of routing nodes and the second plurality of routing nodes.

5. The method of claim 1, further comprising:
assigning a beginning track sequence index corresponding to an ordinal position before the plurality of track sequence indexes and assigning an ending track sequence index corresponding to an ordinal position after the plurality of track sequence indexes to the two virtual routing boundaries; and
setting up routing edges, each one of the routing edges connecting two routing nodes of the first plurality of routing nodes, two routing nodes of the second plurality of routing nodes, one of the two virtual routing boundaries and one routing node of the first plurality of routing nodes, or the one of the two virtual routing boundaries and one routing node of the second plurality of routing nodes.

6. The method of claim 5, wherein the setting up the routing edges for the first plurality of routing nodes comprises:
setting up, based on a first graph of the first plurality of routing nodes, a first set of fundamental edges between adjacent routing nodes and between routing nodes and boundaries within individual slices;
setting up a second set of fundamental edges between routing nodes of adjacent slices; and
setting up, based on geometric arrangements of corresponding track sequence indexes, extra edges between pairs of the first plurality of routing nodes, in response to the extra edges having insufficient routing capacities or meeting one or more selection criteria.

7. The method of claim 6, wherein:
the setting up the first set of fundamental edges is based on an edge length less than a reference distance, or
the setting up the second set of fundamental edges is based on a Delaunay triangulation process.

8. The method of claim 1, wherein
the first and second pluralities of predicted traces are each independently monotonic with respect to a propagating direction between the first area and the second area, band-bounding with respect to respective one or more bands of the first plurality of routing nodes or the second plurality of routing nodes defined based on the propagating direction, or cross-free with respect to the propagating direction.

9. The method of claim 1, further comprising:
deriving, based on a first graph of the first plurality of routing nodes, a first set of possible track mapping solutions of the first plurality of routing nodes;
determining, based on the first set of possible track mapping solutions and a second graph of the second plurality of routing nodes, a set of feasible track mapping solutions between the first plurality of routing nodes and the second plurality of routing nodes; and
determining, based on the set of feasible track mapping solutions, a track mapping graph and identifying one or more track mapping solutions.

10. The method of claim 1, further comprising:
deriving respective first and second sets of possible track mapping solutions of the first plurality of routing nodes and the second plurality of routing nodes based on respective first and second graphs of the first plurality of routing nodes and the second plurality of routing nodes;
determining a set of feasible track mapping solutions between the first plurality of routing nodes and the second plurality of routing nodes based on the first set of possible track mapping solutions and the second set of possible track mapping solutions; and
determining a track mapping graph and identifying one or more track mapping solutions based on the set of feasible track mapping solutions.

11. The method of claim 1, further comprising:
obtaining a first set of possible track mapping solutions of the first plurality of routing nodes;
determining a set of feasible track mapping solutions between the first plurality of routing nodes and the second plurality of routing nodes based on the first set of possible track mapping solutions and a second graph of the second plurality of routing nodes; and
determining a track mapping graph and identifying one or more track mapping solutions based on the set of feasible track mapping solutions.

12. The method of claim 1, further comprising:
obtaining respective first and second sets of possible track mapping solutions of the first plurality of routing nodes and the second plurality of routing nodes;
determining a set of feasible track mapping solutions between the first plurality of routing nodes and the second plurality of routing nodes based on the first set of possible track mapping solutions and the second set of possible track mapping solutions; and
determining a track mapping graph and identifying one or more track mapping solutions based on the set of feasible track mapping solutions.

13. The method of claim 1, further comprising:
determining presence or absence of at least one feasible track mapping solution between the first plurality of routing nodes and the second plurality of routing nodes;
in response to a determination of an absence of at least one feasible track mapping solution between the first plurality of routing nodes and the second plurality of routing nodes, adjusting a first graph of the first plurality of routing nodes or a second graph of the second plurality of routing nodes for obtaining one or more modified track mapping solutions; and
determining a track mapping graph and identifying one or more track mapping solutions based on at least the one or more modified track mapping solutions.

14. A processing device for routing traces of an interconnect structure, comprising:
a memory device; and
processing circuitry coupled to the memory device and configured to:
derive respective capacity information for a first plurality of routing nodes in a first area of the interconnect structure and a second plurality of routing nodes in a second area of the interconnect structure, each routing node of the first and second pluralities of routing nodes being associated with a corresponding track sequence index of a plurality of track sequence indexes, the first and second pluralities of routing nodes together with two virtual routing boundaries defining respective first and second pluralities of routing edges, and the respective capacity information indicating, for individual routing edges of a subset of the respective first and second pluralities of routing edges, one or more passing track sequence indexes or a number of traces accommodable by the routing edge;
generate, based on the respective capacity information, a first plurality of predicted traces connecting the first plurality of routing nodes and a second plurality of predicted traces connecting the second plurality of routing nodes;
generate, based on the first plurality of predicted traces and the second plurality of predicted traces, a plurality of traces connecting the first plurality of routing nodes and the second plurality of routing nodes; and
store the plurality of traces connecting the first plurality of routing nodes and the second plurality of routing nodes.

15. The processing device of claim 14, wherein the processing circuitry is further configured to:
derive a first set of possible track mapping solutions of the first plurality of routing nodes based on a first graph of the first plurality of routing nodes;
determine a set of feasible track mapping solutions between the first plurality of routing nodes and the second plurality of routing nodes based on the first set of possible track mapping solutions and a second graph of the second plurality of routing nodes; and
determine a track mapping graph and identify one or more track mapping solutions based on the set of feasible track mapping solutions.

16. The processing device of claim 14, wherein the processing circuitry is further configured to:
derive respective first and second sets of possible track mapping solutions of the first plurality of routing nodes and the second plurality of routing nodes based on respective first and second graphs of the first plurality of routing nodes and the second plurality of routing nodes;
determine a set of feasible track mapping solutions between the first plurality of routing nodes and the second plurality of routing nodes based on the first set of possible track mapping solutions and the second set of possible track mapping solutions; and
determine a track mapping graph and identify one or more track mapping solutions based on the set of feasible track mapping solutions.

17. The processing device of claim 14, wherein the processing circuitry is further configured to:
obtain a first set of possible track mapping solutions of the first plurality of routing nodes;
determine a set of feasible track mapping solutions between the first plurality of routing nodes and the second plurality of routing nodes based on the first set of possible track mapping solutions and a second graph of the second plurality of routing nodes; and
determine a track mapping graph and identify one or more track mapping solutions based on the set of feasible track mapping solutions.

18. The processing device of claim 14, wherein the processing circuitry is further configured to:
obtain respective first and second sets of possible track mapping solutions of the first plurality of routing nodes and the second plurality of routing nodes;
determine a set of feasible track mapping solutions between the first plurality of routing nodes and the second plurality of routing nodes based on the first set of possible track mapping solutions and the second set of possible track mapping solutions; and
determine a track mapping graph and identify one or more track mapping solutions based on the set of feasible track mapping solutions.

19. The processing device of claim 14, wherein the processing circuitry is further configured to:
obtain respective first and second sets of possible track mapping solutions of the first plurality of routing nodes and the second plurality of routing nodes;
in response to a determination of no feasible track mapping solution between the first plurality of routing nodes and the second plurality of routing nodes based on the first set of possible track mapping solutions and the second set of possible track mapping solutions, adjust a first graph of the first plurality of routing nodes or a second graph of the second plurality of routing nodes for obtaining one or more modified track mapping solutions; and
determine a track mapping graph and identify one or more track mapping solutions based on at least the one or more modified track mapping solutions.

20. A non-transitory computer-readable medium that stores instructions which, when executed by processing circuitry of a processing device, cause the processing device to:
derive respective capacity information for a first plurality of routing nodes in a first area of an interconnect structure and a second plurality of routing nodes in a second area of the interconnect structure, each routing node of the first and second pluralities of routing nodes being associated with a corresponding track sequence index of a plurality of track sequence indexes, the first and second pluralities of routing nodes together with two virtual routing boundaries defining respective first and second pluralities of routing edges, and the respective capacity information indicating, for individual routing edges of a subset of the respective first and second pluralities of routing edges, one or more passing track sequence indexes or a number of traces accommodable by the routing edge;
generate, based on the respective capacity information, a first plurality of predicted traces connecting the first plurality of routing nodes and a second plurality of predicted traces connecting the second plurality of routing nodes;
generate, based on the first plurality of predicted traces and the second plurality of predicted traces, a plurality of traces of the interconnect structure connecting the first plurality of routing nodes and the second plurality of routing nodes; and
store the plurality of traces of the interconnect structure connecting the first and second pluralities of routing nodes.
